(19) United States
(12) Patent Application Publication
(10) Pub. No.: US 2026/0082344 A1
(43) Pub. Date: Mar. 19, 2026

(54) COMMUNICATING A SYNCHRONIZATION PREAMBLE AND RESPONSE

(71) Applicant: Lenovo (United States) Inc., Morrisville, NC (US)

(72) Inventors: Sher Ali Cheema, Ilmenau (DE); Robin Rajan Thomas, Bad Nauheim (DE); Khaled Nafez Rauf Ardah, Ilmenau (DE)

(21) Appl. No.: 19/397,693

(22) Filed: Nov. 21, 2025

(51) Int. Cl. H04W 56/00; H04W 74/0833

(52) U.S. Cl. CPC H04W 56/002; H04W 74/0833

(57) ABSTRACT

Various aspects of the present disclosure relate to transmitting a preamble for synchronization on a resource; receiving a response message based at least in part on the transmitted preamble for synchronization, wherein the response message comprises at least one parameter for synchronization including one or more time and frequency correction values, wherein the one or more time and frequency correction values are associated with the resource, and wherein the response message is received on a channel dedicated for pre-synchronization; and transmitting one or more random access messages using the at least one parameter for synchronization including the one or more time and frequency correction values.

### TECHNICAL FIELD

The present disclosure relates to wireless communications, and more specifically to techniques for communicating (e.g., transmitting, receiving, or the like) a preamble for synchronization and a response, for example, based at least in part on the transmitted preamble for synchronization.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G) radio access technology, etc.).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to cause the UE to transmit a preamble for synchronization on a resource; receive a response message based at least in part on the transmitted preamble for synchronization, wherein the response message comprises at least one parameter for synchronization including one or more time and frequency correction values, wherein the one or more time and frequency correction values are associated with the resource, and wherein the response message is received on a channel dedicated for pre-synchronization; and transmit one or more random access messages using the at least one parameter for synchronization including the one or more time and frequency correction values.

A processor (e.g., a standalone processor chipset, or a component of a UE) for wireless communication is described. The processor may be configured to, capable of, or operable to transmit a preamble for synchronization on a resource; receive a response message based at least in part on the transmitted preamble for synchronization, wherein the response message comprises at least one parameter for synchronization including one or more time and frequency correction values, wherein the one or more time and frequency correction values are associated with the resource, and wherein the response message is received on a channel dedicated for pre-synchronization; and transmit one or more random access messages using the at least one parameter for synchronization including the one or more time and frequency correction values.

A method performed or performable by a UE is described. The method may include transmitting a preamble for synchronization on a resource; receiving a response message based at least in part on the transmitted preamble for synchronization, wherein the response message comprises at least one parameter for synchronization including one or more time and frequency correction values, wherein the one or more time and frequency correction values are associated with the resource, and wherein the response message is received on a channel dedicated for pre-synchronization; and transmitting one or more random access messages using the at least one parameter for synchronization including the one or more time and frequency correction values.

A base station for wireless communication is described. The base station may be configured to, capable of, or operable to cause the base station to configure a resource grid comprising periodic time-frequency resources for transmission of a preamble for synchronization; receive the preamble for synchronization on a resource of the resource grid; transmit a response message based at least in part on the transmitted preamble for synchronization, wherein the response message comprises at least one parameter for synchronization including one or more time and frequency correction values, wherein the one or more time and frequency correction values are associated with the resource, and wherein the response message is transmitted on a channel dedicated for pre-synchronization; and receive one or more random access messages using the at least one parameter for synchronization including the one or more time and frequency correction values.

A processor (e.g., a standalone processor chipset, or a component of a base station) for wireless communication is described. The processor may be configured to, capable of, or operable to configure a resource grid comprising periodic time-frequency resources for transmission of a preamble for synchronization; receive the preamble for synchronization on a resource of the resource grid; transmit a response message based at least in part on the transmitted preamble for synchronization, wherein the response message comprises at least one parameter for synchronization including one or more time and frequency correction values, wherein the one or more time and frequency correction values are associated with the resource, and wherein the response message is transmitted on a channel dedicated for pre-synchronization; and receive one or more random access messages using the at least one parameter for synchronization including the one or more time and frequency correction values.

A method performed or performable by a base station is described. The method may include configuring a resource grid comprising periodic time-frequency resources for transmission of a preamble for synchronization; receiving the preamble for synchronization on a resource of the resource grid; transmitting a response message based at least in part on the transmitted preamble for synchronization, wherein the response message comprises at least one parameter for synchronization including one or more time and frequency correction values, wherein the one or more time and frequency correction values are associated with the resource, and wherein the response message is transmitted on a channel dedicated for pre-synchronization; and receiving one or more random access messages using the at least one parameter for synchronization including the one or more time and frequency correction values.

### BRIEF DESCRIPTION OF THE DRAWINGS

FIG. 1 illustrates an example of a wireless communications system, in accordance with aspects of the present disclosure.

FIG. 2 illustrates an example of satellite operation and transmission of a synchronization preamble (SP) and a synchronization response (SR) message, in accordance with aspects of the present disclosure.

FIG. 3 illustrates an example of a UE-side pre-synchronization procedure, in accordance with aspects of the present disclosure.

FIG. 4 illustrates an example of a network-side pre-synchronization procedure, in accordance with aspects of the present disclosure.

FIG. 5 illustrates an example of SP transmission and SR message association, in accordance with aspects of the present disclosure.

FIG. 6 illustrates an example of a SR frame with preamble, in accordance with aspects of the present disclosure.

FIG. 7 illustrates an example of a SR timeline, in accordance with aspects of the present disclosure.

FIG. 8 illustrates an example of a protocol stack, in accordance with aspects of the present disclosure.

FIG. 9 illustrates an example of a UE, in accordance with aspects of the present disclosure.

FIG. 10 illustrates an example of a processor, in accordance with aspects of the present disclosure.

FIG. 11 illustrates an example of an NE, in accordance with aspects of the present disclosure.

FIG. 12 illustrates a flowchart of methods performed by a UE in accordance with aspects of the present disclosure.

FIG. 13 illustrates a flowchart of methods performed by an NE in accordance with aspects of the present disclosure.

### DETAILED DESCRIPTION

Some wireless communication system may support a non-terrestrial network (NTN) for radio access by various devices, such as UEs, satellites, and/or other NEs, which may transmit and/or receive signaling. These wireless communication systems may support include wireless communication between a UE and a satellite via the NTN. However, in order for the UE to access the NTN, the UE has to possess global navigation satellite system (GNSS) capabilities. GNSS coordinates enabled the UE to determine (or identify) its position, which is then used to pre-compensate time and frequency offsets. For example, 3GPP new radio (NR) NTN utilizes an open-loop timing adjustment procedure for transparent payload NTN architecture. In this procedure, the timing advance (TA) is partitioned into a common TA (i.e., corresponding to feeder link round trip time (RTT)) and user-specific TA (corresponding to the two-way transmission delay on the service link). To estimate the user-specific TA, the UE has to know (e.g., identify, obtain, determine) serving satellite position (e.g., position information provided by the NTN to the UE) and its own location (e.g., obtained based at least in part via GNSS). Moreover, because non-geostationary orbit satellites are constantly moving, the UE may be required to continuously update the TA and frequency pre-compensation while in a connected mode (e.g., an radio resource control (RRC) connected mode). Therefore, the UE requires a reliable GNSS connection during its connectivity to ensures stable access to the NTN.

Although GNSS provides a highly accurate position and timing reference, there could be multiple occasions/scenarios in which GNSS signals may be unavailable or unreliable for a duration (e.g., period of time). For example, GNSS signals may be subject to outages, intentional or unintentional jamming, or spoofing. These GNSS signals may result in inaccurate UE position estimate, which in turn may cause the user-specific TA to be miscalculated (e.g., determined), thereby impairing uplink (UL) communication and effectively denying NTN connectivity. Such scenarios may simultaneously impact a group of UEs within a cell. Additionally, there could be occasions in which a UE may experience degraded NTN service due to reduced GNSS location estimates (e.g., accuracy reduced to 300m). This reduction may occur for several reasons, such as poor GNSS link budget, unavailability of a number of satellites (i.e., an insufficient number of visible satellites), or a position of the UE (e.g., in a pocket or bag). These conditions can collectively diminish the reliability of GNSS-based position estimation and consequently impact NTN service quality.

Moreover, some UEs within the cell may lack GNSS capability. Such UEs may be unable to connect to the NTN because these UEs might not perform the accurate time and frequency synchronization procedure that is based on first estimating their own location using GNSS. For example, if a UE perform a time and frequency synchronization during initial access without GNSS-based pre-compensation, the UE's first random-access channel (RACH) preamble may arrive at the base station (e.g., gNB) with potentially significant timing errors (due to unknown RTT) and frequency errors (due to unknown Doppler shift). These impairments can substantially increase the likelihood of initial access failures or misdetections under existing procedures.

Various aspects of the present disclosure provide techniques for improving NTN access by implementing a GNSS-independent pre-synchronization mechanism. This mechanism enables unsynchronized UEs to obtain (e.g., acquire) coarse timing and frequency alignment reliably and with low overhead, thereby increasing the likelihood that a random-access procedure succeeds under NTN radio conditions (e.g., subject to significantly greater Doppler and delay spreads as compared to terrestrial networks). By way of example, a UE may transmit, and an NE may receive, a preamble for synchronization (e.g., configured, generated) for detection in significant Doppler and delay spreads. In some examples, the preamble for synchronization may utilize a waveform resilient to large frequency offset errors. In some other examples, the preamble for synchronization may have (e.g., possess) auto-correlation properties for improved detection even in the presence of large timing offset errors.

In some examples, the NE may compute coarse TA and Doppler estimates corresponding to a detected preamble for synchronization, and may also transmit a response to the UE, where the response contains one or more timing and frequency correction values, and where the timing and frequency correction values are based on the detected preamble. For example, the response may include an identifier (ID) or index corresponding to the detected preamble and a set of delay correction and/or frequency correction values based on the detected preamble. By supporting a GNSS-independent pre-synchronization mechanism and facilitating coarse synchronization without relying on GNSS, UEs may achieve initial access to the NTN despite any GNSS jamming, GNSS spoofing, or environmental conditions that may prevent reception of or exacerbate the unavailability of GNSS signals. As another benefit, by supporting a GNSS-independent pre-synchronization mechanism and facilitating coarse synchronization without relying on GNSS, UEs may experience reduced power consumption, decreased processing complexity, and improved initial-access efficiency.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

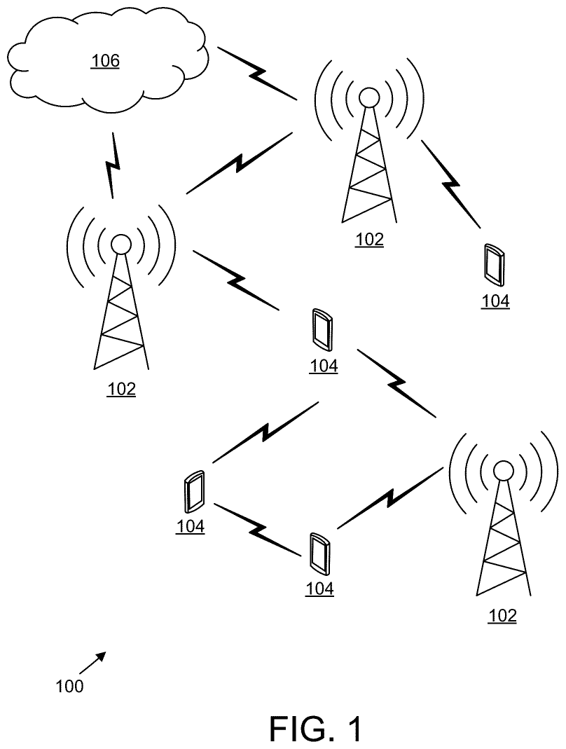

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various RATs. In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In some other implementations, the wireless communications system 100 may be a 6G radio (6GR) network, such as a 6G network. In other implementations, the wireless communications system 100 may be a combination of a 4G network and/or a 5G network and/or a 6G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a NTN. In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, X2, N2, N3, Xn, F1-C, F1-U, or another network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, X2, N2, N3, Xn, F1-C, F1-U, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., μ=2) may be associated with a third SCS value (e.g., 60 kHz) and a normal cyclic prefix or an extended cyclic prefix. A fourth numerology (e.g., μ=3) may be associated with a fourth SCS value (e.g., 120 kHz) and a normal cyclic prefix. A fifth numerology (e.g., μ=4) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 millisecond (msec) duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHz-7.125 GHz), frequency range #2 (FR2) (e.g., 24.25 GHz-52.6 GHz), frequency range #3 (FR3) (e.g., 7.125 GHz-24.25 GHz), frequency range #4 (FR4) (e.g., 52.6 GHz-114.25 GHz), frequency range #4a (FR4a) or frequency range #4-1 (FR4-1) (e.g., 52.6 GHz-71 GHz), and frequency range #5 (FR5) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

In the wireless communication system 100, one or more UEs 104 may transmit a respective preamble for synchronization (also referred to herein as a synchronization preamble (SP)). An SP may be associated with one or more characteristics (e.g., bandwidth (BW), number of resources (e.g., symbols, physical resource blocks, or the like), or other waveform/signal properties). Each of the one or more UEs 104 may transmit a respective SP over a channel configured (e.g., dedicated) for pre-synchronization. By way of example, the wireless communication system 100, including the one or more UEs 104 may support transmission, and one or more NEs 102 may support reception, of a respective SP over a channel configured for pre-synchronization, which may be referred to herein as a pre-synchronization channel (PSCH).

In some implementations, the NE 102 may monitor the channel configured for pre-synchronization (e.g., the PSCH) to detect (e.g., receive, obtain) one or more SPs transmitted by one or more UEs 104, respectively. In some examples, the NE 102 may monitor the PSCH using one or more Doppler-aware correlation techniques. In response to, or based at least in part on detecting (e.g., receiving, obtaining) a respective SP, the NE 102 may compute (e.g., determine, calculate) one or more coarse TA and Doppler estimates associated with the detected SP. In some implementations, the NE 102 may generate a response, for example, for each detected (e.g., received, obtained) SP, respectively. The response may also be referred to herein as a synchronization response (SR), and may include information (e.g., indications, parameters, fields, information elements, or the like) that indicates the one or more computed coarse TA and Doppler estimates.

Additionally, the wireless communication system 100, including the one or more NEs 102 may support transmission (e.g., broadcasting), and one or more UEs 102 may support reception, of an SR over a channel configured for pre-synchronization, which may be referred to herein as a pre-synchronization response channel (PSRCH). For example, the NE 102 may broadcast a SR message to the one or more UEs 104 (e.g., all UEs within a coverage area of the NE 102 or the coverage area of a transmit beam of the NE 102). As another example, the NE 102 may communicate (e.g., transmit) the SR message to a particular UE 104 (or a specific group of UEs 104), e.g., using dedicated signaling. The SR message may include an ID of a PSCH resource corresponding to a detected (e.g., received) SP and information (e.g., indications of, or containing, quantized TA corrections and/or quantized Doppler corrections). In some examples, to reduce overhead signaling, the SR message may be compact and include only the information of (i.e., indication of, or containing) the coarse TA and Doppler-shift corrections without the additional signaling structure of RRC, MAC, or other PHY-layer messages. This allows efficient GNSS-independent pre-synchronization while minimizing overhead. In certain examples, the SR message may include an ID pointing to a transmission resource (e.g., PSCH resource) associated with the detected SP. In some other examples, the NE 102 may implicitly indicate the transmission resource (e.g., PSCH resource) associated with the detected SP, e.g., using a time and/or frequency resource used to transmit the SR, or the position of a particular SR message in a burst comprising multiple SR messages.

After transmitting an SP, a UE 104 may monitor the PSRCH (e.g., during a monitoring window) for a SR transmission. By way of example, the monitoring window may be defined relative to a transmission occasion or radio frame corresponding to the SP transmission, e.g., with a start time relative to an end of the SP transmission occasion or SP frame. The UE 104 can expect to receive an SR transmission (i.e., comprising one or more SR message) within the monitoring window duration. In response to, or based at least in part on, receiving the SR transmission, the UE 104 may identify (e.g., match) the SR messages based at least in part on the PSCH resource (e.g., based on an ID included in the SR message), apply the TA and/or Doppler corrections (pre-synchronization), and perform a RACH procedure, for example, at least a physical random-access channel (PRACH) transmission. By applying these pre-synchronization corrections (e.g., the TA and/or Doppler corrections), the UE 104 may perform a RACH procedure with residual timing and frequency errors kept within terrestrial tolerances, i.e., tolerances expected in terrestrial networks.

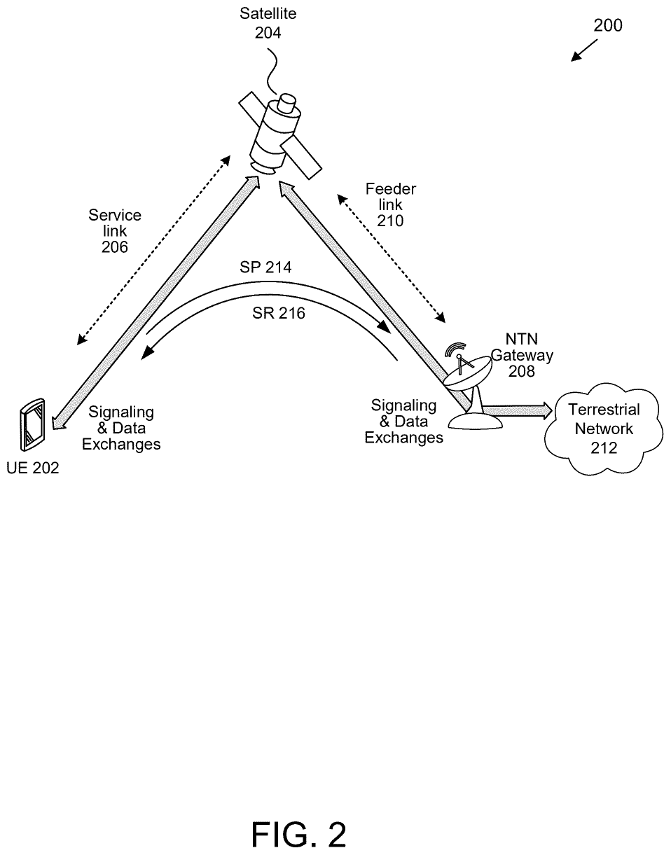

FIG. 2 illustrates an example of a satellite operation 200, in accordance with aspects of the present disclosure. The satellite operation 200 may implement or be implemented by aspects of the wireless communication system 100. For example, the satellite operation 200 may include a UE 202 which connects to a satellite 204 via a service link 206. The UE 202 may implement or be implemented by a UE 104 as described herein. Additionally, the satellite operation 200 may include an NTN gateway 208 which connects to the satellite 204 via a feeder link 210. The NTN gateway 208 is a satellite ground/earth device that facilitates communication with a terrestrial network 212, such as the CN 106. In the example of FIG. 2, the NTN gateway 208 is co-located with a gNB (e.g., an implementation of the NE 102). The NTN gateway 208 may implement or be implemented by an NE 102 as described herein. In one or more implementations, the satellite operation 200 in a wireless communications system with satellite access provides a communication service for one or more UEs 202 under satellite coverage.

Aspects of the present disclosure include techniques for enabling the UE 202 to transmit a preamble for synchronization (e.g., SP transmission 214) on a pre-synchronization resource (e.g., the PSCH) and receive, for example, from the NTN gateway 208, a response message (e.g., SR transmission 216) based at least in part on the transmitted preamble for synchronization. In some implementations, the response message includes at least one parameter for synchronization, such as one or more time correction values (e.g., coarse TA corrections) and/or one or more frequency correction values (e.g., coarse Doppler corrections). In at least some implementations, the one or more time and frequency correction values are associated with the selected resource (i.e., the PSCH resource used to transmit the SP 214). In at least some implementations, the response message is received on a channel dedicated for pre-synchronization (e.g., the PSRCH).

With regards to scheduling and timing, the downlink (DL) and the UL may be frame-aligned at a UL time synchronization reference point (RP) with an offset given by N_{TA,offset} (see, e.g., clause 4.2 of 3GPP technical specification (TS) 38.213). In some embodiments, the UL time synchronization RP may be located between the NTN gateway 208 and the satellite 204.

To accommodate the propagation delay in NTNs, several timing relationships may be enhanced by a common TA and two offsets K_{offset} and k_{mac}: The common TA is a configured timing offset that is equal to the RTT between the UL time synchronization RP and the NTN payload. The offset K_{offset} is a configured scheduling offset that needs to be larger or equal to the sum of the RTT of the service link 206 (referred to as “service link RTT”) and the common TA. The offset k_{mac} is a configured offset that is approximately equal to the RTT between the UL time synchronization RP and the NTN gateway 208.

The scheduling offset K_{offset} is used to allow the UE 202 sufficient processing time between a DL reception and an UL transmission, for example, as described in TS 38.213. The offset k_{mac} is used to delay the application of a DL configuration indicated by a medium access control (MAC) control element (CE) command on the physical downlink shared channel (PDSCH), for example, as described in TS 38.213, and in estimation of the RTT between the UE 202 and the NTN gateway 208, for example, as described in 3GPP TS 38.321. The offset k mac may be provided to the UE 202 (e.g., by the network) when DL and UL frame timing are not aligned. The k_{mac} is also used in the random-access procedure, to determine the start time of random-access response (RAR) window/MsgB window after a Msg1/MsgA transmission, for example, as described in TS 38.213.

With regards to hybrid automated repeat request (HARQ) operation in NTN, the network may configure the HARQ operation as follows:

For the DL, the network (e.g., NTN gateway 208) may enable or disable HARQ feedback per HARQ process. Disabling the HARQ feedback allows the network to schedule a HARQ process before one HARQ RTT has elapsed since last scheduled.

For the UL, the network (e.g., NTN gateway 208) HARQ mode (i.e., HARQ mode A or HARQ mode B) can be configured per HARQ process. HARQ mode B allows the network to schedule a HARQ process before one HARQ RTT has elapsed since last scheduled.

For the HARQ processes configured with HARQ feedback enabled/disabled, it is up to network implementation to ensure a proper configuration of HARQ feedback (e.g., either all enabled or all disabled) for HARQ processes used by a semi-persistent scheduling (SPS) configuration. For the HARQ processes configured with the HARQ mode, it is up to network implementation to ensure a proper configuration of the HARQ mode (e.g., either all HARQ mode A or all HARQ mode B) for HARQ processes used by a configured grant (CG) configuration. CG refers to a semi-persistently scheduled grant of recurring (e.g., semi-static) network resources.

With regards to TA and frequency pre-compensation, for the serving cell, the network broadcast valid ephemeris information and common TA parameters. Conventional systems may require the UE 202 to have a valid GNSS position as well as ephemeris information and common TA before connecting to an NTN cell. To achieve synchronization, before and during connection to an NTN cell, the UE 202 computes the RTT between the UE 202 and the UL time synchronization RP (or NTN gateway 208) based on the GNSS position of the UE 202, the ephemeris of the satellite 204, and the common TA parameters (e.g., as described in TS 38.213). Additionally, the UE 202 is expected to autonomously pre-compensate the TTA for the RTT between the UE 202 and the UL time synchronization RP (or NTN gateway 208).

In some examples, the UE 202 may compute a frequency Doppler shift of the service link 206, and autonomously pre-compensate for the Doppler shift in the UL transmissions, for example, by considering the GNSS position of the UE 202 and the ephemeris of the satellite 204. However, in conventional systems the UE 202 is not allowed to transmit unless it has both A) a valid GNSS position (and/or a valid ephemeris) and B) the common TA. As used herein, the satellite ephemeris information refers to a set of data that describes the precise position and velocity of a satellite (e.g., the satellite 204) in its orbit, i.e., at specific points in time. The UE 202 may acquire the ephemeris information via network broadcast, i.e., by receiving a system information block (SIB) transmitted by the NTN gateway 208 (and relayed via the satellite 204). In NTN networks, SIB type 19 (SIB-19) may be used to provide satellite ephemeris and assistance information.

In connected mode, the UE 202 is able to continuously update the TA and frequency pre-compensation. In certain implementations, the UE 202 may be configured to report its TA during random-access procedures or in connected mode. In connected mode, the UE 202 may support event-triggered reporting of the TA.

While the pre-compensation of the instantaneous Doppler shift experienced on the service link 206 is to be performed by the UE 202, the management of Doppler shift experienced over the feeder link 210 and transponder frequency error is left to the network implementation.

With regard to transmission timing adjustments, the UE 202 may be provided with a value N_{TA,offset} of a TA offset for a serving cell by n-TimingAdvance Offset for the serving cell. If the UE 202 is not provided with the parameter n-TimingAdvance Offset for a serving cell, then the UE 202 may determine a default value N_{TA,offset} of the TA offset for the serving cell. In certain implementations, if the UE 202 is configured with two UL carriers for a serving cell, a same TA offset value N_{TA,offset} applies to both carriers.

In response to, or based at least in part on, reception of a timing advance command (TAC) for a timing advance group (TAG), the UE 202 may adjust the UL timing for UL transmissions (including physical uplink shared channel (PUSCH) transmissions, sounding reference signal (SRS) transmissions, and physical uplink control channel (PUCCH) transmission) on all the serving cells in the TAG based on a value N_{TA,offset} that the UE 202 expects to be same for all the serving cells in the TAG and based on the received TAC where the UL timing for PUSCH (or SRS or PUCCH) transmissions is the same for all the serving cells in the TAG. The TAC refers to a command sent from the gNB (i.e., co-located with the NTN gateway 208) to a particular UE 202 to correct the UE's UL transmission timing, ensuring that the UL signals from that UE 202 arrive at the NTN gateway 208 within the correct time window, thus mitigating inter-symbol interference between signals from different UEs and different time slots.

For a band with synchronous contiguous intra-band EN-DC in a band combination with non-applicable maximum transmit timing difference requirements, if the UE 202 indicates the parameter ul-TimingAlignmentEUTRA-NR as ‘required’ and UL transmission timing based on timing adjustment indication for a TAG from a master cell group (MCG) and a TAG from a secondary cell group (SCG) are determined to be different by the UE 202, then the UE 202 adjusts the transmission timing for PUSCH (or SRS or PUCCH) transmission on all serving cells part of the band with the synchronous contiguous intra-band EN-DC based on timing adjustment indication for a TAG from a serving cell in MCG in the band. The UE 202 is not expected to transmit a PUSCH (or SRS or PUCCH) in one CG when the PUSCH (or SRS or PUCCH) transmission is overlapping in time, even partially, with a random access preamble transmitted in another CG.

For a SCS of 2^{μ}·15 kHz, the TAC for a TAG indicates the change of the UL timing relative to the current UL timing for the TAG in multiples of 16·64·T_{c}/2^{μ}. The start timing of the random access preamble may be as described in 3GPP TS 38.211. The TAC in case of a RAR or in an absolute TAC MAC CE, TA, for a TAG indicates N_{TA} values by index values of T_{A}=0, 1, 2, . . . , 3846, where an amount of the time alignment for the TAG with SCS of 2^{μ}·15 kHz is N_{TA}=T_{A}·16·64/2^{μ}. N_{TA} and is relative to the SCS of the first UL transmission from the UE 202 after the reception of the RAR or absolute TAC MAC CE.

In other cases, a TAC, T_{A}, for a TAG indicates adjustment of a current N_{TA} value, N_{TA}_{ₒ}_{ld}, to the new N_{TA} value, N_{TA}_{ₙ}_{ew}, by index values of T_{A}=0, 1, 2, . . . , 63, where for a SCS of 2^{μ}·15 kHz, N_{TA}_{ₙ}_{ew}=N_{TA}_{ₒ}_{ld}+ (T_{A}−31)·16·64/2^{μ}.

If the UE 202 has multiple active UL bandwidth parts (BWPs), as described in clause 12, in a same TAG, including UL BWPs in two UL carriers of a serving cell, the TAC value is relative to the largest SCS of the multiple active UL BWPs. The applicable N_{TA}_{ₙ}_{ew} value for an UL BWP with lower SCS may be rounded to align with the TA granularity for the UL BWP with the lower SCS, for example, while satisfying the TA accuracy requirements.

Adjustment of an N_{TA} value by a positive or a negative amount indicates advancing or delaying the UL transmission timing for the TAG by a corresponding amount, respectively.

In some examples, for a TAC received on UL slot n and for a transmission other than a PUSCH scheduled by a RAR UL grant or a fallbackRAR UL grant, or a PUCCH with HARQ-ACK information in response to a successRAR message, the corresponding adjustment of the UL transmission timing applies from the beginning of UL slot n+k+1+2^{μ}·K_{offset} where

$$k = ⌈ {N}_{slot}^{subframe , μ} \cdot ( {N}_{T , 1} + {N}_{T , 2} + {N}_{TA , max} + 0 \text{.5} ) / {T}_{sf} ⌉ ,$$

N_{T,1} is a time duration in msec of N₁ symbols corresponding to a PDSCH processing time for UE processing capability 1 when additional PDSCH demodulation reference signal (DM-RS) is configured, N_{T,2} is a time duration in msec of N₂ symbols corresponding to a PUSCH preparation time for UE processing capability 1, N_{TA,max} is the maximum TA value in msec that can be provided by a TA command field of 12 bits,

$${N}_{slot}^{subframe , μ}$$

is the number of slots per subframe, T_{sf} is the subframe duration of 1 msec, and K_{offset}=K_{cell,offset}−K_{UE,offset}, where K_{cell,offset} is provided by cellSpecifickoffset and K_{UE,offset} is provided by a Differential Koffset MAC CE command.

Otherwise, if not respectively provided, K_{cell,offset}=0 or K_{UE,offset}=0. N₁ and N₂ are determined with respect to the minimum SCS among the SCSs of all configured UL BWPs for all UL carriers in the TAG and of all configured DL BWPs for the corresponding DL carriers. For μ=0, the UE 202 may assume N_{1,0}=14. Slot n and are

$${N}_{slot}^{subframe , μ}$$

are determined with respect to the minimum SCS among the SCSs of all configured UL BWPs for all UL carriers in the TAG. N_{TA,max} is determined with respect to the minimum SCS among the SCSs of all configured UL BWPs for all UL carriers in the TAG and for all configured initial UL BWPs provided by the parameter initialUplinkBWP. The UL slot n is the last slot among UL slot(s) overlapping with the slot(s) of PDSCH reception assuming T_{TA}=0, where the PDSCH provides the TAC and T_{TA}.

In some examples, if the UE 202 changes an active UL BWP between a time of a TAC reception and a time of applying a corresponding adjustment for the UL transmission timing, then the UE 202 may determine the TAC value based on the SCS of the new active UL BWP. Similarly, if the UE 202 changes an active UL BWP after applying an adjustment for the UL transmission timing, then the UE 202 assumes a same absolute TAC value before and after the active UL BWP change.

With regard to DL timing adjustment, if the received DL timing changes and is not compensated or is only partly compensated by the UL timing adjustment without TAC, the UE 202 changes the N_{TA} value accordingly. For example, if two adjacent slots overlap due to a TA command, the latter slot may be reduced in duration relative to the former slot. In some implementations, the UE 202 does not change N_{TA} during an actual transmission time window for a PUSCH or a PUCCH transmission.

Using higher-layer ephemeris parameters for a serving satellite, if provided, a UE 202 may pre-compensate the two-way transmission delay on the service link 206, for example, based on

$${N}_{TA , adj}^{UE}$$

that the UE 202 determines using the serving satellite position and its own position.

To pre-compensate the two-way transmission delay between the UL time synchronization RP and the serving satellite, the UE 202 may determine the value

$${N}_{TA , adj}^{c o m m o n}$$

based on one-way propagation delay formula, Delay_{common}(t), defines as follows:

$${Delay}_{comm o n} ( t ) = \frac{T {A}_{c o m m o n}}{2} + \frac{T {A}_{CommonDrift}}{2} \times ( t - {t}_{e p o c h} ) + \frac{T {A}_{CommonDriftVariant}}{2} \times {( t - {t}_{e p o c h} )}^{2}$$

where TA_{Common}, TA_{CommonDrift}, and TA_{CommonDriftVariant} are respectively provided by parameters ta-Common, ta-CommonDrift, and ta-CommonDriftVariant and t_{epoch} is provided by epochTime which is the epoch time of ta-Common, ta-CommonDrift, and ta-CommonDriftVariant. The formula Delay_{common}(t) provides a distance at time t between the serving satellite and the UL time synchronization RP divided by the speed of light. The UL time synchronization RP is the point where DL and UL are frame aligned with an offset given by N_{TA,offset}.

In some examples, the NTN gateway 208 may provide the UE 202 with an information element (IE) for an NTN configuration (e.g., NTN-Config IE) that contains the essential parameter information needed for calculation of common TA and user-specific TA. An exemplary NTN-Config IE is described in 3GPP TS 38.331 (see, e.g., FIG. 16.14.2.1-1). Fields in the NTN-Config IE may include one or more of the following: EphemerisInfo, epochTime, cellSpecificKoffset, Kmac, ntn-PolarizationDL, ntn-PolarizationUL, ntn-UlSyncValidityDuration, ta-Common, ta-CommonDrift, ta-CommonDriftVariant, and ta-Report.

The field EphemerisInfo provides satellite ephemeris either in format of position and velocity state vector or in format of orbital parameters. In certain implementations, this field may be excluded when determining changes in system information, i.e., changes to ephemerisInfo should neither result in system information change notifications nor in a modification of valueTag in the SIB type 1 (SIB-1) that contains scheduling information and core system information.

The field epochTime indicates the epoch time for the NTN assistance information. When explicitly provided through SIB, or through dedicated signaling, the EpochTime is the starting time of a DL sub-frame, indicated by a system frame number (SFN) and a sub-frame number signaled together with the assistance information. For serving cell, the field sfn indicates the current SFN or the next upcoming SFN after the frame where the message indicating the epochTime is received. For neighbor cell, the field sfn indicates the SFN nearest to the frame where the message indicating the epochTime is received. The reference point for epoch time of the serving NTN payload ephemeris and common TA parameters is the UL time synchronization RP. If this field is absent, the epoch time is the end of a system information (SI) window where this SIB-19 is scheduled.

In certain implementations, the field epochTime may be mandatory/present when provided in a dedicated configuration. If this field is absent in ntn-Config provided via IE NTN-NeighCellConfig then the UE 202 may use the epoch time of the serving cell; otherwise, the field is based on the timing of the serving cell, i.e. the SFN and sub-frame number indicated in this field refers to the SFN and sub-frame of the serving cell. In case of handover or conditional handover, this field is based on the timing of the target cell, i.e. the SFN and sub-frame number indicated in this field refers to the SFN and sub-frame of the target cell. For the target cell the UE 202 considers epoch time, indicated by the SFN and sub-frame number in this field, to be the frame nearest to the frame in which the message indicating the epoch time is received. In certain implementations, the field epoch Time may be excluded when determining changes in system information, i.e., changes to epochTime should neither result in system information change notifications nor in a modification of valueTag in SIB-1.

The field cellSpecificKoffset provides a cell-specific value for the scheduling offset K_{offset} used for the timing relationships that are modified for NTN. In some examples, the unit of the field K_{offset} is number of slots for a given SCS of 15 kHz. If the field is absent, then the UE 202 may use the default value ‘0’.

The field K_{mac} provides a scheduling offset provided by network if DL and UL frame timing are not aligned at the gNB (e.g., co-located with NTN gateway 208). It is needed for UE action and assumption on DL configuration indicated by a MAC CE command in PDSCH. If the field is absent, then the UE 202 may use the default value ‘0’. For the reference SCS value for the unit of K_{mac} in FR1, a value of 15 kHz is used. The unit of K_{mac} is number of slots for a given SCS.

The field ntn-PolarizationDL, if present, indicates polarization information for DL transmission on service link: including Right-hand circular polarization (RHCP), Left-hand circular polarization (LHCP) and Linear polarization.

The field ntn-PolarizationUL, if present, this parameter indicates polarization information for UL service link. However, if not present and ntn-PolarizationDL is present, then the UE 202 assumes the same polarization for UL and DL.

The field ntn-UlSyncValidityDuration indicates a validity duration configured by the network for assistance information (i.e., serving satellite ephemeris and/or neighbor satellite ephemeris and common TA parameters) which indicates the maximum time duration (from epochTime) during which the UE 202 may apply assistance information without having acquired new assistance information. In some implementations, the unit of ntn-UlSyncValidityDuration is second. Value s5 corresponds to 5 seconds, value s10 indicate 10 seconds, and so on. In some implementations, the parameter ntn-UlSyncValidityDuration applies to both connected and idle mode UEs. If this field is absent in ntn-Config provided via NIN-NeighCellConfig, the UE 202 uses validity duration from the serving cell assistance information. This field is excluded when determining changes in system information, i.e. changes of ntn-UlSyncValidityDuration should neither result in system information change notifications nor in a modification of valueTag in SIB-1. In some implementations, the ntn-UlSyncValidityDuration is only updated when at least one of epochTime, ta-Info, ephemerisInfo is updated.

The field ta-Common indicates a network-controlled common TA value, and it may include any timing offset considered necessary by the network. The field ta-Common with value of 0 is supported. The granularity of ta-Common is 4.072×10\hat{ }(−3) microseconds (μs). Values are given in unit of corresponding granularity. The field ta-Common may be excluded when determining changes in system information, i.e., changes of ta-Common should neither result in system information change notifications nor in a modification of valueTag in SIB-1.

The field ta-CommonDrift indicates drift rate of the common TA. The granularity of ta-CommonDrift is 0.2×10\hat{ }(−3) μs/s. Values are given in unit of corresponding granularity. The field ta-CommonDrift may be excluded when determining changes in system information, i.e., changes of ta-CommonDrift should neither result in system information change notifications nor in a modification of valueTag in SIB-1.

The field ta-CommonDriftVariant indicates drift rate variation of the common TA. The granularity of ta-CommonDriftVariation is 0.2×10\hat{ }(−4) μs/s\hat{ }2. Values are given in unit of corresponding granularity. The field ta-CommonDriftVariant may be excluded when determining changes in system information, i.e., changes of ta-CommonDriftVariant should neither result in system information change notifications nor in a modification of valueTag in SIB-1.

The field ta-Report, when included in SIB-19, indicates reporting of TA is enabled during a random-access procedure due to RRC connection establishment or RRC connection resume, and during RRC connection reestablishment. However, when this field is included in ServingCellConfigCommon within dedicated signaling, it indicates TA reporting is enabled during the random-access procedure due to reconfiguration with synchronization.

In NR NTN transparent payload architecture, a UE 202 pre-compensates the two-way transmission delay on the service link 206 based on its TA calculation, which is determined by the UE 202 using the position of the satellite 204 and the position of the UE 202. For this purpose, the following formula is used to determine the TA (referred to as open loop TA procedure):

$${T}_{T A} = ( {N}_{T A} + {N}_{TA , offset} + {N}_{T A , a d j}^{c o m m o n} + {N}_{T A , a d j}^{UE} ) {T}_{s}$$

where N_{TA} denotes the TA component based on accumulating “TA commands” received from the network/NTN gateway 208 (e.g., by MAC CE command) and is reset to zero whenever there is RACH procedure to acquire TA estimates, while

$${N}_{T A , a d j}^{UE}$$

denotes the TA component specific to satellite communications and is determined by the UE 202 based on the UE's own location and the NTN serving satellite's ephemeris, thus accuracy of

$${N}_{TA , adj}^{UE}$$

depends on the accuracy of the location information.

As discussed above, a conventional NTN system assumes that the UE 202 has GNSS capabilities and calculates its own position using GNSS. However, GNSS is prone to spoofing and jamming. GNSS spoofing may lead to incorrect location reporting and potentially denial of service on a temporary basis, for example, for the time period of the spoofing. GNSS jamming may also lead to denial of service on a temporary basis (e.g., for the time period of the jamming) or a location accuracy which has been artificially degraded. Additionally, natural phenomena, such as solar radiation bursts, may affect large parts of the earth surface on a temporary basis (e.g., for 10 to 20 minutes) and thus may also result in temporary unavailability of GNSS signals, resulting in denial of service.

Referring again to FIG. 1, to support GNSS-independent synchronization in NTN, techniques are described for pre-synchronization to facilitate an unsynchronized UE 104 to acquire coarse timing and frequency alignments reliably and with low overhead, so that the subsequent standard random-access procedure succeeds in NTN conditions. The GNSS-independent pre-synchronization allows the UE 104 to resolve initial timing and frequency uncertainties prior to transmitting an initial random-access message (e.g., RACH Msg1, RACH MsgA, etc.), thereby mitigating random-access failure without requiring GNSS capabilities or a current, GNSS-based position of the UE 104.

According to aspects of a first solution, the wireless communication system 100 (e.g., NE 102 and UEs 104) may implement a two-phase pre-synchronization mechanism for acquiring time and/or frequency correction values based on the UE 104 transmitting a UL preamble to the NE 102, i.e. prior to transmitting a RACH preamble (e.g., RACH Msg1/MsgA).

In some implementations, the NE 102 may support a channel dedicated for UL pre-synchronization signaling, referred to herein as a pre-synchronization channel (PSCH). In some examples, the PSCH corresponds to a UL grid composed of multiple time-frequency resources where UEs 104 can transmit one or more preambles for synchronization (referred to herein as SPs). In some examples, the PSCH is a fixed region of resources allocated for SP transmission and may be located in a carrier with a relative time and/or frequency offset, for example, relative to the starting point of a slot or physical resource block (PRB).

In some implementations, the NE 102 supports a channel dedicated for DL pre-synchronization signaling, referred to herein as a pre-synchronization response channel (PSRCH). In some implementations, the NE 102 transmits DL feedback to the SPs on the PSRCH. In some examples, the NE 102 may perform a DL broadcast transmission to transmit one or more response messages (i.e., SRs) containing timing and frequency corrections based on one or more SPs received by the NE 102. In some examples, the PSRCH is a fixed region of resources allocated for SR transmission and may be located in a carrier with a relative time and/or frequency offset, for example, relative to the starting point of a slot or PRB, and not overlapping with the PSCH.

In some implementations, during the first phase of pre-synchronization the UE 104 may first transmit an SP on a specific PSCH resource, for example, that the UE 104 selects based on a defined configuration. In some examples, the SP transmitted by the UE 104 is a specially designed waveform capable of being detected and estimated under large Doppler and timing offsets. In certain examples, the UE 104 may transmit such waveforms in signal bursts over the entire configured BW to improve robustness against noise and interference, wherein a burst duration may be further configured by the NE 102.

During the second phase of pre-synchronization, the NE 102 may: A) detect the SP transmitted by the UE 104, B) estimate the coarse TA and Doppler offset of the UE, and then C) transmit an SR message containing quantized TA and/or Doppler correction values (i.e., corresponding to the coarse TA and Doppler offset estimates). In response to, or based at least in part on, receiving this SR, the UE 104 may apply the indicated corrections and proceeds with the conventional random-access procedure (e.g., by transmitting a RACH preamble, which is a different sequence than the preamble for synchronization).

In some implementations, the pre-synchronization mechanism may be regarded as a “Step 0” to handle coarse uncertainty before handing off the existing RACH procedure for fine-tuning of the TA and Doppler offsets. Beneficially, the pre-synchronization mechanism allows the UEs 104 in a cell to acquire coarse synchronization parameters without requiring a dedicated UE-based signaling and also avoiding the overhead of assigning temporary IDs during the fragile pre-synchronization state.

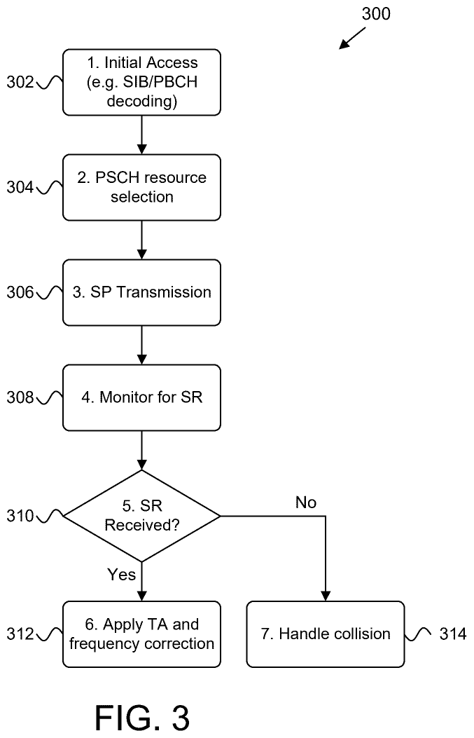

FIG. 3 illustrates a pre-synchronization procedure 300 from the UE perspective, in accordance with aspects of the present disclosure. The pre-synchronization procedure 300 may implement or be implemented by aspects of the wireless communication system 100. For example, the pre-synchronization procedure 300 may be implemented by a UE 104 and an NE 102 as described herein.

At step 1, a UE 104 initiating an initial access procedure with no valid timing or frequency reference first decodes PSCH and PSRCH information, for example, broadcasted by the NE 102 in SIB and/or PBCH of the cell (see block 302). In certain implementations, the PSCH and PSRCH information may be transmitted via an existing or enhanced SIB, for example, SIB-1 or SIB-19 or via a newly defined SIB.

At step 2, after decoding the PSCH and PSRCH information, the UE 104 may then select a PSCH resource based on the decoded configuration parameters for PSCH (see block 304).

At step 3, once the PSCH resource is selected, the UE 104 may transmit an SP signal on the chosen PSCH grid resource (see block 306).

At step 4, after transmitting the SP, the UE 104 may monitor (i.e., listen) for a corresponding SR, for example, during a configured SR monitoring window (see block 308). In certain implementations, the SR monitoring window comprises a part of the PSCH and PSRCH information and may be configured via the existing or enhanced SIB.

At step 5, if the UE 104 successfully detects an SR message (i.e., containing at least one or more of a TA and/or a frequency correction value) corresponding to its transmitted SP (see block 310), then at step 6 the UE 104 will proceed to apply the TA and frequency correction values contained in the SR to align its UL transmission before moving on to the PRACH procedure (see block 312). If not successful, then at step 7 the UE 104 may assume a collision has occurred and perform collision handling, for example, by waiting for the next PSCH frame to re-transmit the SP or re-trying with a new PSCH resource, depending on access control policies (see block 314).

In certain implementations, the SR monitoring window is a new type of SP response (SPR) window and/or corresponds to an SPR timer defined for SP transmissions on the PSCH. In the case of an SPR window, the UE 104 can expect to receive the SPR within the allocated window duration of this new type of SPR window before triggering another SP transmission. The SPR window may be characterized with a window ID corresponding to the SP frame or SP transmission occasion, where the window length may be pre-defined (e.g., configured or indicated in the SI), and with a start time relative to the SP frame or SP transmission occasion.

Alternatively, an SPR timer may be defined where upon transmission of the SP, the UE 104 starts the SPR timer and monitors for the reception of the SPR. In response to, or based at least in part on, expiry of this SPR timer, the UE 104 may trigger another SPR transmission. The NE 102 may configure the SPR window or SPR timer to the UE 104, for example, using broadcast signaling or based on a pre-configuration. The SPR window and/or SPR timers may be adjusted, for example, extended/longer duration values, to consider the NTN propagation delay, type of NTN satellite, ephemeris, additional processing time, etc.

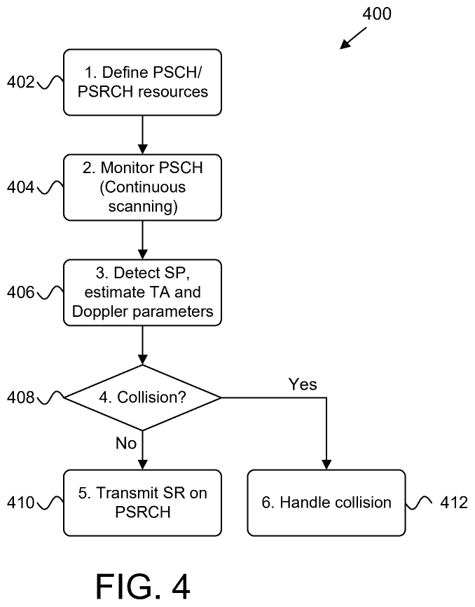

FIG. 4 illustrates a pre-synchronization procedure 400 from the network perspective, in accordance with aspects of the present disclosure. The pre-synchronization procedure 400 may implement or be implemented by aspects of the wireless communication system 100. For example, the pre-synchronization procedure 400 may be implemented by an NE 102 and a UE 104 as described herein.

At step 1, the NE 102 may first define the PSCH and PSRCH resources, for example, the NE 102 may determine the time-frequency grid resources for the PSCH and PSRCH (see block 402). The NE 102 may then configure the UEs 104 with required parameters, for example, by transmitting PSCH and PSRCH information in the SIB and/or PBCH of the cell (see block 402).

At step 2, the NE 102 may then perform continuous scanning of the UL band corresponding to the PSCH, for example, to detect incoming SPs transmitted by one or more UEs 104 (see block 404).

At step 3, In response to, or based at least in part on, detecting one or more SPs, the NE 102 may estimate the coarse TA and frequency offset values (i.e., correction values) for each detected SP (see block 406).

At step 4, the NE 102 may determine if any collisions are detected, i.e., multiple SPs overlapping in the same resource (see block 408). It will be understood that the NE 102 may both detect collision-free SP on one SPCH resource and determine that a collision has occurred on another SPCH resource of the same SPCH frame.

At step 5, if at least one collision-free SP is detected, then the NE 102 may generate and transmit a corresponding SR message associated with the detected SP resource ID on the PSRCH (see block 410). In some implementations, each SR message contains at least one or more of a TA and/or a frequency correction value.

At step 6, if a collision is detected, then the NE 102 may initiate a collision handling process to resolve the overlapping SPs received from multiple UEs (see block 412). In certain implementations, the collision handling process includes the NE 102 performing multi-user separation (if feasible). In certain implementations, the collision handling process includes the NE 102 broadcasting a shared SR corresponding to the collided SP, or a reattempt instruction associated with the collided SP. In certain implementations, the collision handling process may include the NE 102 initiating an SP contention resolution procedure to resolve the SP collisions.

Because the NE 102 may need to indicate to the UE 104 about the PSCH and PSRCH resources to transmit and receive SP and SR, one or more of the following example implementations may be followed to configure the resources for pre-synchronization mechanism describe herein.

In some implementations, the NE 102 and UE 104 implement the pre-synchronization mechanism as a pre-condition add-on (i.e., a pre-step (step-0)) to the existing NR RACH mechanism. In such an implementation, the NE 102 may broadcast the configuration for PSCH and PSRCH resources, for example, as part of SI broadcasting. Such implementation may be useful, if a UE 104 is able to have enough initial DL time and frequency synchronization to decode PBCH and eventually one or more SIBs (e.g., SIB-1 and/or SIB-19).

In certain implementations, the NE 102 may use a dedicated DL discovery beacon (which may be referred to as a broadcast discovery channel (BDCH)) to configure the PSCH grid and PSRCH parameters, where this discovery beacon is transmitted continuously (or at known intervals) via the satellite beam. In one example, the discovery beacon carries minimal but critical configuration information that allows an unsynchronized UE 104 to discover and align to network timing and frequencies with coarse accuracy (i.e., a timing and frequency accuracy sufficient for the UE 104 to avoid transmission failure or collision when transmitting the SP).

Moreover, such implementations may employ an ultra-robust waveform (e.g., spread binary phase-shirt keying (BPSK) or chirp) that can tolerate tens of kHz of frequency offset. This allows even an unsynchronized UE 104 (e.g., those UEs 104 that do not have timing or frequency synchronization, and thus cannot decode SIBs) to detect the beacon energy pattern, measure DL frequency, and decode the PSCH and PSRCH information/parameters. Still further, a UE 104 trying to acquire synchronization can align its SP transmissions approximately to beacon epochs. As used herein, a beacon epoch refers to a scheduled time interval during which a satellite is expected to transmit specific beacon signals.

In some other implementations, the PSCH and PSRCH parameters may be pre-configured or pre-provisioned at the UE 104 and/or may be embedded in the hardware of the UE 104. Having pre-determined PSCH and PSRCH information may be especially useful for low-cost IoT or fixed-function UEs 104, where these parameters can be preloaded in the firmware or subscriber identify module (SIM). In such implementations, a UE 104 only needs to find the right beam's carrier by scanning those few frequencies that are pre-provisioned, similar to the access class barring tables for narrowband IoT (NB-IoT). In certain examples, the access class barring tables for an NTN-capable NB-IoT UE 104 may be enhanced by also including PSCH and PSRCH information as described herein.

According to aspects of a second solution, the preamble for synchronization (i.e., SP) is designed to be a “zero-payload” signal, where its purpose is not to transmit information directly, but for the network to infer timing or frequency synchronization information (e.g., TA and Doppler offset values) from its physical characteristics. Therefore, in some implementations, the SP itself carries no explicit bits of information and the NE 102 does not attempt to decode the SP. Moreover, an attempt to decode the SP would not yield any meaningful information as the SP is a form of pilot signal transmitted by the UE 104 for synchronization purposes.

Accordingly, in certain implementations, all the essential information of an SP is conveyed implicitly through the resource (i.e. PSCH grid resource) that the SP occupies, the transmitted signal and its measured physical properties. Consequently, the SP may have a zero-payload design because adding any explicit bits of information (e.g., a temporary ID, a few bits of location information) would require dedicating signal power to carrying those bits. In the initial-access stage, every milliwatt of power must be dedicated to detecting the signal's presence and estimating time uncertainties (Δt) and frequency uncertainties (Δf). Beneficially, a zero-payload design maximizes the processing gain and allows the SP to be reliably detected at the lowest possible signal-to-noise ratio (SNR), which is critical for a weak, long-distance satellite links.

In some implementations, the UE 104 transmits an SP that consists of a constant-amplitude zero auto-correlation (CAZAC) sequence. In certain implementations, the SP is a Zadoff-Chu (ZC) sequence, which is a type of CAZAC sequence. The constant-amplitude property of a CAZAC sequence means that the SP has low peak-to-average power ratio (PAPR), thus allowing the UE 104's power amplifier to transmit the SP at a higher average power without distortion, which is critical for a weak, long-distance satellite link. Moreover, the ideal auto-correlation property of a CAZAC sequence creates a single, sharp, unambiguous peak when correlated at the receiver (i.e., when the SP is correlated by the NE 102), thus allowing for accurate and precise timing estimation by the NE 102.

The base sequence is a ZC root sequence of length N_{ZC}, selected from a set of roots with prime lengths (e.g., 139 or 839) to ensure ideal periodic auto-correlation (zero out-of-phase) and low cross-correlation between different cyclic shifts. This orthogonality allows multiple UEs 104 to share the same time-frequency resources by using distinct cyclic shifts, reducing collision probability in dense deployments.

In some implementations, a UE 104 may generate the ZC sequence zᵤ(n) for root index u using the function:

$${z}_{u} ( n ) = {e}^{( \frac{- j π un ( n + 1 )}{{N}_{ZC}} )} , \qquad n = 0 , 1 , … , {N}_{ZC} - 1$$

where u is coprime to N_{ZC}. A cyclic shift v is applied to create orthogonal variants: z_{u,v}(n)=zᵤ((n+v) mod N_{ZC}), supporting up to N_{ZC} unique preambles per root. To estimate the time uncertainties (Δt), the NE 102 may continuously scan for the ZC sequence. Because ZC sequences have a perfect, sharp auto-correlation peak, the NE 102 can determine the exact arrival time of the SP signal, for example, by correlating the received signal with the known sequence. Moreover, the NE 102 may determine a coarse TA estimate based on the timing of this auto-correlation peak.

In some implementations, an extremely high Doppler shift experienced by the NE 102 and/or UE 104 may cause the auto-correlation peak of ZC to blur, split, and/or shift in time, thereby making the TA estimate inaccurate or impossible. Therefore, to enhance Doppler resilience, the UE 104 may modulate the ZC sequence (or other CAZAC sequence) with a linear frequency chirp, which combines the advantageous properties of ZC sequences with linear frequency modulation (chirp). The chirp sweeps the instantaneous frequency across the occupied bandwidth, BW, over the symbol duration Tₛ, following:

$$c ( t ) = {f}_{0} + \frac{μ}{2} t , \qquad 0 \leq t < {T}_{s}$$

where f₀ is the starting frequency (typically the subcarrier center), and μ=BW/Tₛ is the chirp rate (in Hz/s). The resulting time-domain chirp signal is

$$c ( t ) = {e}^{j 2 π ( {f}_{0} t + \frac{μ}{2} {t}^{2} )} .$$

The hybrid Chirp-ZC sequence s(t) is obtained by sample-wise multiplication of the time-domain ZC sequence with the chirp: s(t)=z_{u,v}(t). c(t), followed by OFDM modulation across the PSCH subcarriers.

Accordingly, the UE 104 may use this hybrid Chirp-ZC sequence design to leverage the ZC's sharp auto-correlation peak for precise timing estimation (resolution≈1/BW) and the chirp's compressive properties for Doppler tolerance. Under high Doppler, traditional ZC preambles suffer from peak splitting or offset, i.e., the NE 102's matched filter would see the auto-correlation peak shift in time, where the amount of time shift of the auto-correlation peak is directly proportional to the Doppler frequency shift.

In some implementations, the NE 102 may perform a 2D correlation search in time delay and frequency to determine the auto-correlation peak. The location of the auto-correlation peak in this 2D search gives both Δt (from the main peak location) and Δf (from the peak shift) simultaneously. Therefore, the use of the chirp ensures the auto-correlation peak remains sharp and detectable even under massive Doppler, allowing estimation ranges up to ±60 kHz (typical in very LEO constellations) without ambiguity.

In some implementations, the UE 104 may transmit the SP in a configurable BW, for example, to cater for satellite deployments in different orbits. In certain implementations, the NE 102 may configure the BW for SP transmission, for example, corresponding to 4, 8, or 12 physical resource blocks (PRBs), translating to 240 kHz, 480 kHz, or 720 kHz. Larger BWs yield finer timing resolution: for BW=720 kHz, δₜ≈1.4 μs, sufficient for coarse TA estimation in LEO satellites (delays ˜1-10 msec).

In high-Doppler environments, the SCS must be significantly larger than the Doppler shift to allow successful reception, since a large Doppler shift would cause severe inter-carrier interference (ICI). Additionally, the NE 102 may configure (and the UE 104 may use) a larger SCS to achieve a wider signal for the same number of subcarriers, thus improving the ability of the NE 102 to estimate the coarse TA. For the Hybrid Chirp ZC waveform, the UE 104 transmitting the SP on a wider BW allows for a faster and more robust chirp rate (μ), further enhancing the tolerance of an SP signal to high Doppler conditions, and this enhancing the ability of the NE 102 to detect/receive the SP transmitted by the UE 104.

Therefore, in one implementation, the NE 102 may select a 60 kHz or 120 kHz SCS for SP. The NE 102 may select 60 kHz or 120 kHz SCS to balance ICI minimization under high Doppler (as ICI is proportional to f_{d}/SCS, where f_{d} is Doppler shift) with SP transmission overhead.

In one implementation, to provide time diversity and enable frequency offset estimation, the NE 102 may configure the UE 104 to transmit the SP consecutively, i.e., R times, where R is configurable repetition count (e.g., 2 to 8). In certain implementations, the NE 102 may signal the value of R to the UE 104 via the PSCH configuration parameters, for example, broadcast through standard SIB or in BDCH. In one example, the UE 104 transmits each SP repetition identically. Alternatively, in another example, the UE 104 may transmit the successive SP repetitions with phase-rotation to aid estimation, as the phase drift between repetitions k and k+1 would facilitate more accurate Doppler estimation by the NE 102.

In one implementation, for enhanced robustness against narrowband interference or fading, the NE 102 and the UE 104 may optionally support frequency-hopping across repetitions of the SP transmission. In one example, the hopping patterns are predefined (e.g., pseudo-random sequences based on cell ID) and the NE 102 may configure the UEs 104 with the hopping patterns via SIB. In certain implementations, the UE 104 implements the frequency hopping shifting the center frequency by multiples of SCS (e.g., ±120 kHz hops) for subsequent transmissions. Beneficially, such implementation would spread the SP signal over a wider effective BW, thereby improving detection probability in jammed and/or noisy environments.

In some implementations, the NE 102 and/or the UE 104 may adapt the chirp rate u for SP transmission to the expected Doppler range. As used herein, the chirp rate μ refers to the slope of the frequency sweep across the occupied bandwidth, BW, over the symbol duration μ=BW/Tₛ. In some implementations, the NE 102 may configure the chirp rate μ via SIB parameters. Accordingly, the UE 104 may determine the chirp rate μ for SP transmission in response to, or based at least in part on, decoding the SIB, for example, SIB-1 and/or SIB-19.

Beneficially, the adaptive chirp rate configuration support the deployment of multi-orbit satellite systems, since a low-rate chirp would maintain high timing resolution (e.g., good for geostationary earth orbiting (GEO) satellites) but would limit the detectable Doppler range. On the other hand, a high-rate chirp would expand the Doppler range (essential for low earth orbiting (LEO) satellites) but would slightly sacrifice the timing resolution. For example, for moderate Doppler (<20 kHz, for example, GEO satellites), a low rate μ=10⁶ Hz/s may be used to maintain correlation sharpness, whereas, for extreme Doppler (>50 kHz, for example, LEO at high elevations), a high rate μ=10⁷ Hz/s may broaden the sweep.

In some implementations, the UEs 104 may select these chirp rates based on a deployment type (e.g., the chirp rate is selected based on the satellite orbit). In one example, the information for selecting chirp rates may be pre-provisioned (e.g., embedded in firmware and/or SIM) for UEs 104 comprising IoT devices or similar lower-complexity devices. In another example, the NE 102 may configure the information for selecting chirp rates to one or more UEs 104 comprising non-IoT devices or similar higher-complexity devices. In certain implementations, the UE 104 may use artificial intelligence (AI) and/or machine learning (ML) models to predict optimal μ from historical synchronization attempts associated with a particular network/satellite deployment.

Generally, a UE 104 performing initial access procedure does not have any idea about its path loss. For instance, if the UE 104 transmits with less power, the signal would be too weak to be detected by the NE 102. Alternatively, if the UE 104 transmits the signal with too much power, the transmission may cause massive interference. Therefore, in some implementations, the NE 102 and/or UE 104 may utilize an open-loop power control mechanism for the transmission of SP, thus ensuring that UEs 104 at the beam edge (i.e., experiencing high path loss) transmit with more power than UEs 104 at the beam center (i.e., experiencing low path loss), normalizing the received power at the satellite.

In some implementations, before transmitting the SP, a UE 104 may first measure the received power of a DL reference signal (e.g., the synchronization signal block (SSB)). From this, the UE 104 estimates the DL path loss (PL). In such implementations, the UE 104 would then calculate its SP transmit power (P_{SP}), for example, using the formula:

$${P}_{S P} [ dBm ] = min ( {P}_{M A X} , {P}_{0 \_ SP} + α \cdot PL )$$

where P_{MAX} is the maximum allowed transmission power of the UE 104, P_{0_SP} is the target power level for the SP required at the NE 102 receiver and α is the fractional path loss compensation factor (e.g., 0.8 or 1.0) that controls how much the UE 104 compensates for its path loss. In one implementation, P_{MAX}, P_{0_SP}, and α are network-controlled. For example, the NE 102 may configure the values for P_{MAX}, P_{0_SP}, and α by including them in the SIB.

In some implementations, one or more UEs 104 may transmit SP signals with a power boost relative to the nominal UL levels, calculated as P_{SP}=P_{MAX}+Δ_{boost}. In certain implementations, the value Δ_{boost} is signaled by the NE 102 to ensure detectability at low SNR (−10 dB or below).

In some implementations, the one or more UEs 104 may apply power ramping across retries. For example, a UE 104 may increase the SP transmit power by a configurable value, for example, 2-3 dB per failed SP attempt, capped at regulatory limits. In certain implementations, the NE 102 may configure the level of power increase the UE 104 applies after a failed SP attempt.

In some implementations, each UE 104 transmits the SP on a time-frequency grid (i.e., PSCH grid), thus enabling contention-based UL access by multiple unsynchronized UEs 104 in NTN. In certain implementations, the NE 102 defines the PSCH grid as a structured set of orthogonal (or quasi-orthogonal) resources where multiple UEs 104 can transmit SPs without prior coordination, thereby minimizing collisions while accommodating large Doppler shifts and timing uncertainties. In some implementations, the NE 102 may configure the UEs 104 with all PSCH grid parameters, for example, via SIB or PBCH broadcast. In some other implementations, the UEs 104 may be pre-provisioned with one or more of the PSCH grid parameters.

In some implementations, the NE 102 may define the PSCH grid as a periodic, two-dimensional (2D) resource structure in the time and frequency domains, for example aligned to the network's super frame or radio frame boundaries. In certain implementations, the NE 102 may dedicate a UL carrier or UL BWP for PSCH operation, where the PSCH frequency resources are separate from the standard PUSCH or PRACH, for example, to mitigate interference. In certain implementations, the NE 102 may define the PSCH grid (i.e., the periodic resource for PSCH transmission) as follows:

PSCH frequency domain structure: the NE 102 may arrange the PSCH grid to span a configurable BW, i.e., divided into PRBs which are configured by the NE 102, where each PRB comprises a plurality of subcarriers (e.g., 12 subcarriers per PRB). In certain implementations, the NE 102 may also configure the SCS for the PSCH grid, for example, to balance Doppler tolerance and overhead. In certain implementations, the UEs 104 may transmit each SP signal in an SP resource that occupies a contiguous block of M PRBs (e.g., M=4 for 240 kHz or M=12 for 720 kHz), selected (e.g., by the NE 102) to provide sufficient BW for timing resolution. In certain implementations, the NE 102 defines the PSCH grid so that SP resources are spaced with guard bands (e.g., 1-2 PRBs) to mitigate adjacent-channel interference from unsynchronized UEs 104.

PSCH time domain structure: the NE 102 may arrange the PSCH grid into PSCH frames of a specific duration (e.g., 1 second periodicity to match satellite beam dwell times), where each PSCH frame contains N slots, and where each slot comprises a plurality of OFDM symbols (e.g., 14 OFDM symbols per slot). In one implementation, the periodicity is also additionally configured by the network to balance access latency and resource efficiency: shorter periodicity value (e.g., 100 msec) for high-mobility scenarios, longer (e.g., 5 s) for delay-tolerant IoT. In some implementations, the UEs 104 transmit SP signals that each span K consecutive OFDM symbols per slot (e.g., K=4 to 12), where K is less than the entirety of the OFDM symbols in a slot. In certain implementations, a UE 104 is configured to reserve the remaining symbols in a slot for a guard period. In certain implementations, a UE 104 is configured to perform one or more repetitions of the SP, for example, using at least a portion of the remaining symbols in a slot.

In some implementations, the NE 102 may define, and the UE 104 may determine, the total number of available SP resources per frame according to the formula:

$${N}_{r e s} = {N}_{freq} \times {N}_{time} \times {N}_{c o d e} ,$$

where N_{freq}=(N_{PRB}/M) is the number of frequency resources, Nₜᵢₘₑ is the number of temporal positions (slots) per frame, and N_{code} is the number of orthogonal code-domain resources per time-frequency slot, derived from cyclic shifts or root sequences of a CAZAC base sequence.

In one implementation, each UE 104 may randomly select a resource index i∈[0 Nᵣₑₛ−1] from the PSCH grid. Each UE 104 may further map the selected resource index to a unique combination of frequency offset, time slot, and code shift. The mapping ensures orthogonality to minimize multi-user interference (MUI) in the wireless communication system 100, where the mapping is deterministic and globally known.

In certain implementations, the UE 104 may map the selected resource index to frequency, time, and code resources as follows:

Frequency Mapping: the UE 104 may map the selected resource index to a center frequency (i.e., frequency-domain resource) that starts at fᵢ=f_{center}+(i mod N_{freq}). (M·12·SCS+G_{f}), where G_{f} corresponds to one or more guard subcarriers (e.g., 120 kHz) to handle frequency errors up to ±10 kHz without overlap.

Time Mapping: the UE 104 may map the selected resource index to a time slot (i.e., time-domain resource) with a slot index defined as sᵢ=[i/N_{freq}]mod Nₜᵢₘₑ, with start time tᵢ=sᵢ·Tₛₗₒₜ+T_{offset}, where T_{offset} accounts for propagation delay tolerance (e.g., cyclic prefix extended to 100 μs).

Code Mapping: the UE 104 may map the selected resource index to a cyclic shift (i.e., code-domain resource) defined as vᵢ=floor i/(N_{freq}·Nₜᵢₘₑ), which the UE 104 applies to the base ZC sequence. In certain implementations, orthogonality may hold as long as shifts are spaced by at least the maximum delay spread (e.g., 10 shifts for 10 μs spread).

In some implementations, each UE 104 may select a transmission time interval (TTI) for the SP transmission, i.e., in randomized manner. In certain implementations, each UE 104 selects the TTI based on a certain probability distribution with a certain mean in terms of time units, for example, msec. By implementing randomized TTIs, the UEs 104 enable multiple SP transmissions to be transmitted in closely spaced (yet non-overlapping) TTIs, which further enable the NE 102 to more easily process the SPs from different UEs 104 within a defined time interval.

In one implementation, the NE 102 may define the PSCH grid capacity with low collision probability P_{coll}≈1−e^{-λ/N}^{ᵣₑₛ} (i.e., Poisson approximation for random access), where λ is the expected number of UEs 104 per frame, for example, for λ=10 and Nᵣₑₛ=40, P_{coll}<0.22.

In some implementations, each SP resource within the pre-synchronization grid is uniquely indexed by a resource identifier/index (RI) i, defined as an integer value corresponding to a distinct combination of frequency-domain position, time-domain slot, and code-domain index. In some implementations, the NE 102 and/or UE 104 may derive the RI in accordance with the following formula:

$$i = v \cdot ( {N}_{f r e q} \cdot {N}_{time} ) + s \cdot {N}_{f r e q} + f$$

where f denotes the frequency index, s denotes the time-slot index, and v denotes the code-domain (cyclic shift) index. In certain implementations, the values of N_{freq}, and Nₜᵢₘₑ are network-configurable parameters (e.g., configured by the NE 102). The RI uniquely defines the time-frequency-code position of the SP transmission within the PSCH frame.

In some implementations, the NE 102 may define the PSCH grid to have a single code-domain resource over the time-frequency grid. In such implementations, the NE 102 and/or UE 104 may derive the RI using the simplified formula:

$$i = s \cdot {N}_{freq} + f$$

This simplification may be used in low-density access scenarios, thereby reducing the complexity of resource detection and mapping.

In some embodiments, the UE 104 selects a RI i according to a uniform or pseudo-random distribution over the available PSCH resources. The mapping between i and its corresponding frequency, time, and code-domain indices is deterministic and known to both the UE 104 and the NE 102. The same mapping may be applied in reverse by the NE 102 to reconstruct the PSCH resource position of a detected SP and to generate an SR message associated with that PSCH resource.

In one implementation, the UE 104 may locally store the PSCH RI (an index corresponding to the time and frequency selected PSCH resources similar to RACH occasion in NR), on which the UE 104 transmits SP.

In response to, or based at least in part on, scanning the satellite band, the UE 104 may search for energy peaks corresponding to primary synchronization signal (PSS) and secondary synchronization signal (SSS) frames and/or BDCH frames. Once detected, the UE 104 may perform a rough frequency offset estimation by correlating consecutive PSS/SSS/BDCH symbols. In some implementations, the decoded BDCH payload (or SIB) includes the PSCH configuration, containing one or more of the following parameters to enable SP transmission and SR reception:

In some implementations, the PSCH configuration may include one or more parameters indicating the center frequency and BW of the PSCH. In certain implementations, the PSCH configuration may include the absolute UL center frequency (f_{c}) and occupied bandwidth, BW, of the PSCH, where the bandwidth defines the occupied spectrum and timing resolution, for example, in terms of number of physical resources blocks. In response to, or based at least in part on, determining the center frequency and occupied bandwidth, the UE 104 may tune its transmitter to the correct UL band, set the appropriate baseband sampling rate, and confine SP transmissions within authorized PSCH spectrum.

In some implementations, the PSCH configuration may include one or more parameters indicating the SCS and numerology that a UE 104 is to use for SP transmission. The SCS determines the OFDM symbol duration and cyclic prefix length. For NTN, larger SCS values are often preferred to mitigate Doppler-induced ICI, whereas shorter symbols reduce phase rotation within one symbol under large Doppler conditions. The NE 102 must know which numerology to expect for the SP signals, and in response to, or based at least in part on, determining the SCS and numerology from the PSCH configuration, the UE 104 configures its baseband OFDM grid for PSCH accordingly.

In some implementations, the PSCH configuration may include a parameter indicating the time-frequency grid size (number of PSCH slots per frame). In certain implementations, multiple UEs 104 may attempt pre-synchronization simultaneously. To reduce collision probability, the PSCH frame is divided into time slots and frequency slots, forming a grid of distinct SP resources, where each SP resource corresponds to a small rectangle on the time-frequency grid. The multiple UEs 104 each randomly pick one resource before transmitting its SP. In certain implementations, the UE 104 may determine the time-frequency grid size from the PSCH configuration, including determining information about the number of frequency partitions, the number of time positions per PSCH frame, and the total number SP resources per PSCH frame.

In some implementations, the PSCH configuration may include a parameter indicating the periodicity of PSCH frames. In certain implementations, the UEs 104 may determine when new PSCH opportunities occur based on the PSCH configuration. Since each UE 104 is initially unsynchronized, the UE 104 may rely on PSS/SSS/BDCH timing markers to determine the PSCH epoch (start time) and periodicity. However, the NE 102 may include information about the periodicity of PSCH frames in the PSCH configuration to ensure that all UEs 104 transmit SPs within aligned time windows, thereby allowing the NE 102 to schedule SR responses predictably. Therefore, in one implementation, the NE 102 may configure a periodicity parameter defining the duration between consecutive PSCH frames. In addition, the NE 102 may configure a PSCH Epoch offset parameter that defines the offset between PSS/SSS or BDCH beacon and the PSCH start. For example, if the BDCH repeats every 1 second, then the UEs 104 may use the beacon arrival as a reference, and determine that the next PSCH frame begins exactly after the offset indicated. This allows all UEs 104 in the beam to transmit SPs roughly aligned in time, simplifying the detection by the NE 102.

In some implementations, the PSCH configuration may include a parameter indicating the repetition factor for SPs. The UEs 104 may use SP repetition to improve the detectability under low SNR conditions and to allow for Doppler estimation from phase drift. In one example, repetition factor would indicate the number of consecutive SP repetitions. In another example, the NE 102 may indicate a separate parameter for nonconsecutive repetitions or repetitions with a gap.

In some implementations, the PSCH configuration may include a parameter indicating a transmit power offset. In certain implementations, during pre-synchronization, a UE 104 does not yet know its pathloss compensation factor because no link budget or power-control command exists. Therefore, the NE 102 may instruct all UEs 104 to transmit SPs at a fixed power offset relative to the nominal PUSCH level, ensuring detectability without excessive interference. For example, the NE 102 may employ a transmit power offset parameter to indicate SP power offset, i.e., transmitting the SP stronger than the nominal value based on the indicated SP power offset value. In certain implementations, the NE 102 may also limit the maximum transmit power, for example, by using an additional transmit power parameter.

According to aspects of a third solution, the SR is a DL signal or message transmitted by the NE 102 (e.g., gNB or satellite node) in response to one or more detected SPs transmitted by UEs 104 over the pre-synchronization UL channel dedicated for pre-synchronization (i.e., the PSCH). In some implementations, the NE 102 uses the SR to communicate coarse synchronization information to a UE 104, specifically to communicate the timing and the frequency pre-compensation values to each UE 104 whose SP was successfully detected by the NE 102. The SR thus enables the UE 104 to achieve a sufficient level of UL time and frequency alignment prior to initiating the standard random-access procedure. In certain implementations, in response to, or based at least in part on, receiving the SR from the NE 102, the UE 104 may achieve a similar level of UL time and frequency alignment as conventional GNSS-based RTT and Doppler pre-compensation. In some other implementations, the SR allows the UE 104 to achieve a higher level of UL time and frequency alignment as conventional GNSS-based techniques.

In some implementations, the NE 102 initiates a SR generation procedure in response to detecting one or more valid SPs on the uplink PSCH grid. In some implementations, the process of detecting the valid SPs provides the following observables for each detected SP: A) the RI or equivalently the (f, s, v) position of the detected SP; B) the coarse arrival time of the SP (i.e., used to estimate propagation delay and TA), and C) the instantaneous frequency offset, or Doppler shift observed on the SP (i.e., used to estimate UL frequency error).

Based on these measurements/observables, the NE 102 may compute the required correction parameters, for example, timing and frequency pre-compensation values for each valid SP detected during a PSCH frame.

In some implementations, the NE 102 transmits the generated SR(s) using an air interface designed for robust transmission under significant Doppler and delay spreads. In certain implementations, the DL resources used to transmit the SR are dedicated resources forming a PSRCH. Characteristics of the air interface for pre-synchronization response messaging may include: low-order modulation, low-rate block coding, pilot-assisted equalization, and/or orthogonal spreading.

In one implementation, the NE 102 may transmit the generated SR(s) using low-order modulation (e.g., BPSK or quadrature phase-shift keying (QPSK) modulation) with a cyclic prefix OFDM (CP-OFDM) waveform may be used for high link margin. Alternatively, the NE 102 may transmit the generated SR(s) using π/2-BPSK modulation with discrete Fourier transform spread OFMD (DFT-s-OFDM) waveform may be employed, making the SR message transmission less sensitive to amplifier non-linearities and phase noise.

In one implementation, the NE 102 may transmit the generated SR(s) using low-rate block coding. In some examples, the NE 102 may use low-density parity check (LDPC) coding or Polar codes, for example, for robust error protection. In block coding, the NE 102 takes a fixed-size block of information bits and transforms it into a larger sized block of codeword bits, i.e., by adding redundant parity bits. The ratio of information bits to total bits is the code rate, which is a value between 0 and 1. Low-rate block coding refers to a block coding technique with a code rate less than 0.5 and generally closer to 0.

In one implementation, the NE 102 may transmit the generated SR(s) using pilot-assisted equalization for tracking may be employed for residual frequency errors, therefore pilot symbols (e.g., DM-RS) may be part of the SR payload. In pilot-assisted equalization for tracking, the receiver (i.e., the NE 102) monitors and adjusts for continuous, rapid changes in the radio channel conditions, such as those caused by satellite mobility.

In one implementation, the NE 102 may transmit the generated SR(s) using chirp-based or CAZAC-based spreading may be used to preserve orthogonality between multiple SRs in the same time window. Accordingly, a chirp-like sequence or CAZAC sequence may be applied to the data signals corresponding to the generated SR(s) for improved orthogonality and low PAPR.

In some implementations, the SR message payload may be based on a fixed or configurable format and may include at least one or more of the following: PSCH RI, timing pre-compensation value and quality, Doppler value, Detection confidence, and integrity code.

In certain implementations, the NE 102 may include the PSCH RI to identify the particular PSCH resource corresponding to the detected SP (e.g., using the frequency index, time-slot index, and code-domain index as described above). As disclosed herein, the PSCH RI is an implicit ID that does not identify a particular UE 104, but rather identifies the UE-selected UL resource that the UE 104 used to transmit the detected SP. In other implementations, the PSCH RI may be implicitly signaled, for example, by the location of the SR.

The timing pre-compensation value is a coarse propagation delay correction value, while the timing pre-compensation quality indicates the timing quality of the timing pre-compensation value. The timing pre-compensation quality is a quantitative measure of how successful this compensation is, for example, high quality or low quality. For example, high timing quality may indicate minimal residual timing errors (e.g., in the nanosecond range), while low timing quality may indicate larger residual timing errors.

The Doppler value gives a frequency offset correction (i.e., either positive or negative). The detection confidence is an optional parameter used by the NE 102 to indicate the quality of SP detection. The integrity code is an error detection code to verify the message integrity of the SR message. In certain implementations, the integrity code may be a cyclic redundancy check (CRC) or a truncated message authentication code.

In some implementations, when the NE 102 transmits a SR payload containing the RI of each detected SP, a UE 104 may implicitly identify whether the received SR is intended for it, i.e., by simply checking whether the RI matches (i.e., points to) the SP the UE 104 transmitted. This is contrary to standard RACH procedures where each UE 104 would embed its preamble ID and receives an RAR addressed to that ID or to a temporary cell radio network temporary identifier (TC-RNTI) associated with the UE 104. Instead, the pre-synchronization process does not include an ID as this step is operated before any identity or fine timing is known.

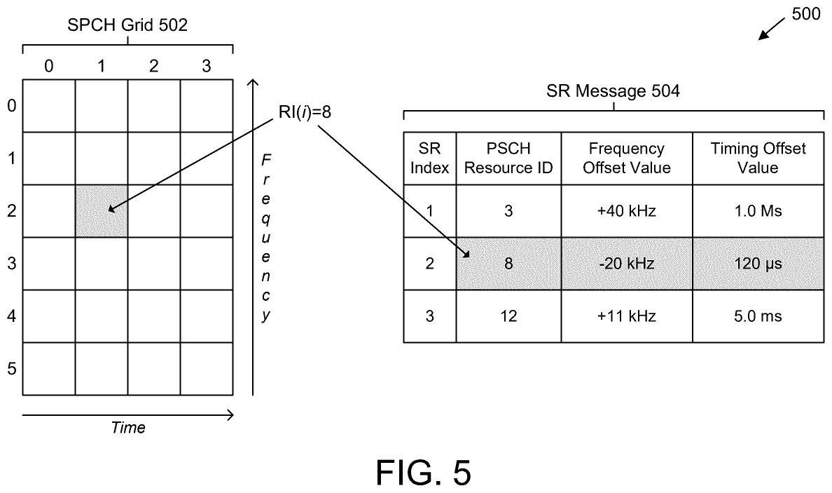

FIG. 5 illustrates an association 500 between an SP transmission (e.g., on a resource from a PSCH resource grid 502) and the corresponding SR message 504, in accordance with aspects of the disclosure. The association 500 may implement or be implemented by aspects of the wireless communication system 100. For example, the association 500 may be implemented by an NE 102 and a UE 104 as described herein.

In the example of FIG. 5, the PSCH resource grid 502 spans six frequency indices (0-5) and four time-slot indices (0-3), defining 24 total uplink SP resources. For example, if the UE 104 transmits its SP on Resource 8, i.e., corresponding to frequency index 2 and time slot 1, the UE 104 will store this RI value locally. In the depicted embodiment, UE 104 may derive the RI using the simplified formula: i=s·N_{freq}+f, such that RI(i)=8 for this SP transmission.

In response to, or based at least in part on, detection of this SP on RI(i)=8 by the NE 102, the NE 102 may estimate the coarse Doppler and TA values corresponding to the detected SP and generate a corresponding SR message 504. The SR message 504 may contain one or multiple lists of PSCH resource IDs corresponding to the detected SPs and corresponding estimated Doppler and TA values for each detected SP. In the depicted embodiment, the NE 102 determined a frequency offset value of −20 kHz and a timing offset value of 120 μs for the SP on RI(i)=8. In response to, or based at least in part on, detection of the SR message 504 (i.e., broadcast by the NE 102 to all UEs in the cell), the transmitting UE 104 would implicitly use the values corresponding to the RI for the transmitted SP. For instance, the UE 104 would apply a Doppler correction of −20 kHz and a TA of 120 μs. In the example of FIG. 5, the implementation supports a specified mapping between RI and the required frequency and timing pre-compensation value.

In one implementation, the NE 102 may transmit the SR message 504 at a deterministic mirror resource location in the DL PSRCH grid, defined as:

$$( {f}_{SP} , {s}_{S P} ) = Φ ( {f}_{SP} , {s}_{S P} )$$

where Φ(f_{SP}, s_{SP}) is a pre-defined mapping function (e.g., frequency mirroring, time offset by fixed Δt), thus allowing UEs 104 to monitor the correct SR resource without explicit signaling.

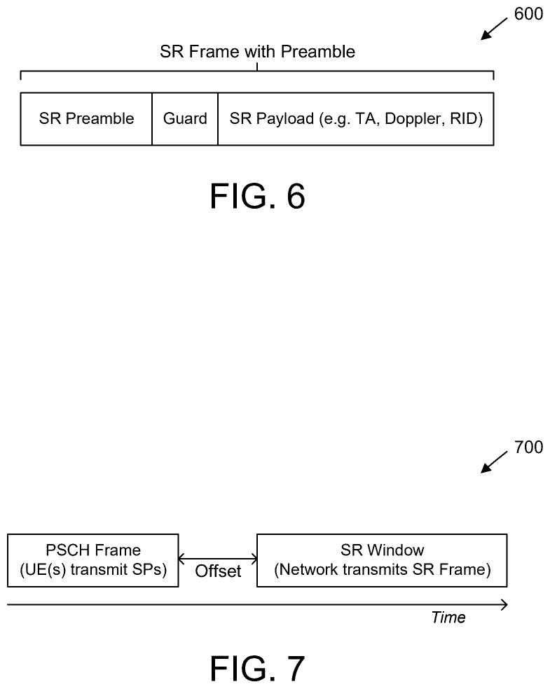

FIG. 6 illustrates an example of a SR frame 600 with preamble, in accordance with aspects of the present disclosure. The SR frame 600 may implement or be implemented by aspects of the wireless communication system 100. For example, the SR frame 600 may be implemented by an NE 102 and a UE 104 as described herein.

In some implementations, each SR frame 600 includes a SR preamble, which is a DL preamble signal preceding the SR payload to enable reliable detection of the SR frame 600 by the UEs 104 that have not yet achieved network synchronization. In certain implementations, the SR preamble may comprise a ZC root sequence, or a linear frequency-modulated (chirp) waveform to provide robustness against large Doppler offsets and timing uncertainties. Such implementations facilitate coarse estimation of the SR arrival time and residual frequency offset, enabling coherent or semi-coherent demodulation of the subsequent SR payload. In certain implementations, each SR frame 600 also includes guard period between the SR preamble and the SR payload, for example, to further improve detection by the UEs 104 that have not yet achieved synchronization.

In some implementations, the NE 102 may transmit the SR message over a dedicated PSRCH, which is time-aligned with each PSCH frame. In certain implementations, each PSRCH frame may contain one or more SR monitoring windows corresponding to PSCH UL frames received earlier by the NE 102. In certain implementations, the NE 102 may transmit multiple SRs within a PSRCH frame using time division multiplexing (TDM) (i.e., where the SRs are placed sequentially in time within the window) or frequency division multiplexing (FDM) (i.e., where the SRs are mapped to distinct frequency sub-bands within the PSRCH BW), or a combination of TDM and FDM.

FIG. 7 illustrates an example of a SR timeline 700, in accordance with aspects of the present disclosure. The SR timeline 700 may implement or be implemented by aspects of the wireless communication system 100. For example, the SR timeline 700 may be implemented by an NE 102 and a UE 104 as described herein.

During the PSCH frame, one or more UEs 104 may transmit SPs to the NE 102. After a pre-determined or configured offset, a SR window begins and the NE 102 transmits an SR frame with SR messages for each detected SP.

After transmission of an SP, the transmitting UE 104 needs to know when and for how long to listen for the corresponding SR. In certain implementations, the SR is not individually scheduled by the NE 102, as the SR is a broadcast message appearing in a predictable window following each PSCH frame. However, without knowledge of the SR window, the transmitting UE 104 could waste power listening continuously for the SR. Accordingly, the NE 102 may transmit a separate block in SIB/BDCH with a PRSCH configuration defining at least some of the following SR window parameters:

SR window start offset: the NE 102 may transmit a parameter defining the offset of SR start from the PSCH frame, for example, 10 msec after PSCH frame. This offset may be expressed in terms of time units or number of symbols according to the configured SCS.

Window duration: the NE 102 may transmit a parameter indicating the total duration of SR listening period.

Repetition factor: the NE 102 may indicate the number of repeated SR transmission in the SR listening window.

Bandwidth: the NE 102 may transmit a parameter indicating DL BW occupied by SR, if SR size is variable, for example, for different orbits (heights) of satellites.

According to aspects of a fourth solution, the NE 102 and a plurality of UEs 104 may support contention-based UL access for pre-synchronization. In contention-based UL access, multiple UEs 104 may attempt to transmit SPs on identical or partially overlapping resources within the PSCH grid. Since the UEs 104 operate without prior timing and frequency synchronization to the network, each UE 104 may independently select a PSCH resource index based on a uniform random distribution across the configured resource space.

Consequently, two or more UEs 104 may select the same time/frequency/code resource, leading to a collision at the NE 102, where the collisions may arise due to either of the reasons, for example, due to identical resource selection, or overlapping Doppler-shifted signals from distinct UEs 104 causing non-orthogonal interference, or because of propagation delay differences causing partial time overlap within the same PSCH slot. When a collision occurs, the received waveform may exhibit multi-peak correlation outputs or non-Gaussian noise characteristics at the NE 102's receiver.

In some implementations, when the collision is resolvable, i.e., where distinct SPs can be separated due to Doppler or timing diversity, the NE 102 may independently estimate the TA and Doppler offset for each SP signature and generate multiple SRs. In certain implementations, each SR may include the RI of the PSCH resource and an additional sequence or index differentiating multiple UEs 104 detected on the same resource, thus allowing more than one UE 104 to successfully complete the pre-synchronization procedure from a single resource index.

In some implementations, when the collision is unresolvable, i.e., where SPs overlap in both time and frequency such that only one combined signal is detected, the NE 102 may transmit no SR corresponding to the ambiguous resource. In certain implementations, the involved UEs 104, in response to, or based at least in part on, failing to detect an SR within the configured SR monitoring window, will interpret the absence of a response as a collision event. Each involved UE 104 may then apply a backoff and retransmission mechanism. For example, in response to, or based at least in part on, determining a collision event, a particular UE 104 may wait for a random backoff duration and then re-select a new PSCH resource index for retransmission. Advantageously, this random backoff and re-selection significantly reduces the likelihood of persistent collisions in subsequent attempts.

In one embodiment, the NE 102 may monitor the estimated load on the PSCH channel, for example, by observing the ratio of detected SPs to transmitted SRs. If a high collision rate is inferred, then the NE 102 may determine and broadcast updated PSCH configuration parameters (e.g., by increasing the PSCH BW, or adding additional code-domain roots, or modifying the SP periodicity), thereby spreading the SP transmissions more evenly across time and frequency.

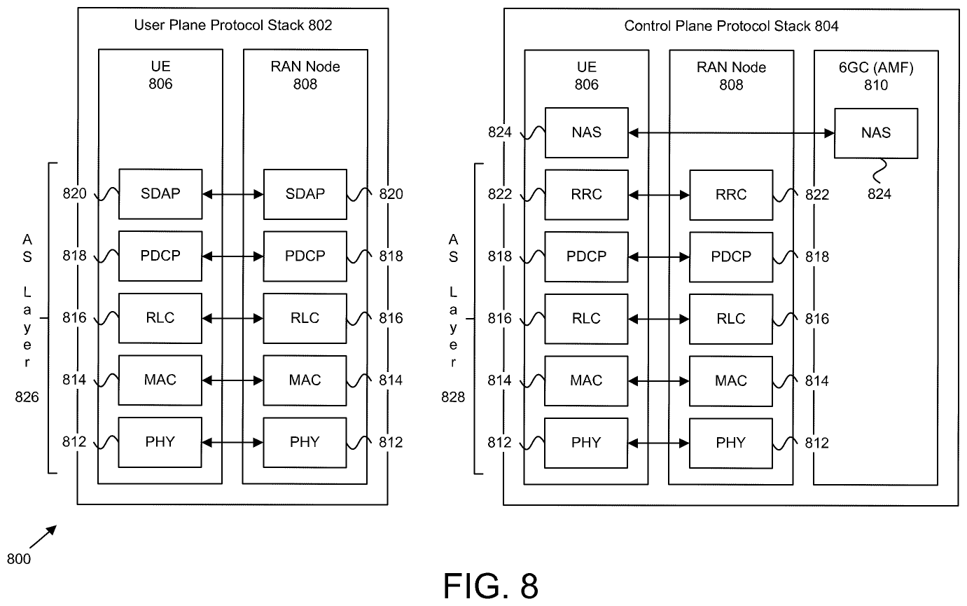

FIG. 8 illustrates an example of a protocol stack 800, in accordance with aspects of the present disclosure. While FIG. 8 shows a UE 806, a RAN node 808, and a 5GC 810 (e.g., including at least an AMF), these are representative of a set of UEs 104 interacting with an NE 102 (e.g., base station) and a CN 106. As depicted, the protocol stack 800 includes a user plane protocol stack 802 and a control plane protocol stack 804. The user plane protocol stack 802 includes a physical (PHY) layer 812, a MAC sublayer 814, a radio link control (RLC) sublayer 816, a packet data convergence protocol (PDCP) sublayer 818, and a service data adaptation protocol (SDAP) sublayer 820. The control plane protocol stack 804 includes a PHY layer 812, a MAC sublayer 814, an RLC sublayer 816, and a PDCP sublayer 818. The control plane protocol stack 804 also includes a RRC layer 822 and a non-access stratum (NAS) layer 824.

The AS layer 826 (also referred to as “AS protocol stack”) for the user plane protocol stack 802 consists of at least the SDAP sublayer 820, the PDCP sublayer 818, the RLC sublayer 816, the MAC sublayer 814, and the PHY layer 812. The AS layer 828 for the control plane protocol stack 804 consists of at least the RRC layer 822, the PDCP sublayer 818, the RLC sublayer 816, the MAC sublayer 814, and the PHY layer 812. The layer-1 (L1) includes the PHY layer 812. The layer-2 (L2) is split into the SDAP sublayer 820, PDCP sublayer 818, RLC sublayer 816, and MAC sublayer 814. The layer-3 (L3) includes the RRC layer 822 and the NAS layer 824 for the control plane and includes, for example, an internet protocol (IP) layer and/or PDU layer (not depicted) for the user plane. L1 and L2 are referred to as “lower layers,” while L3 and above (e.g., transport layer, application layer) are referred to as “higher layers” or “upper layers.”

The PHY layer 812 offers transport channels to the MAC sublayer 814. The PHY layer 812 may perform a beam failure detection procedure using energy detection thresholds, as described herein. In certain implementations, the PHY layer 812 may send an indication of beam failure to a MAC entity at the MAC sublayer 814. The MAC sublayer 814 offers logical channels (LCHs) to the RLC sublayer 816. The RLC sublayer 816 offers RLC channels to the PDCP sublayer 818.

The PDCP sublayer 818 offers radio bearers to the SDAP sublayer 820 and/or RRC layer 822. The SDAP sublayer 820 offers QoS flows to the core network (e.g., 5GC). The RRC layer 822 provides for the addition, modification, and release of carrier aggregation (CA) and/or dual connectivity. The RRC layer 822 also manages the establishment, configuration, maintenance, and release of signaling radio bearers (SRBs) and data radio bearers (DRBs).

The NAS layer 824 is between the UE 806 and an AMF in the 5GC 810. NAS messages are passed transparently through the RAN. The NAS layer 824 is used to manage the establishment of communication sessions and for maintaining continuous communications with the UE 806 as it moves between different cells of the RAN. In contrast, the AS layers 826 and 828 are between the UE 806 and the RAN (i.e., RAN node 808) and carry information over the wireless portion of the network. While not depicted in FIG. 8, the IP layer exists above the NAS layer 824, a transport layer exists above the IP layer, and an application layer exists above the transport layer.

The MAC sublayer 814 is the lowest sublayer in the L2 architecture of the NR protocol stack. Its connection to the PHY layer 812 below is through transport channels, and the connection to the RLC sublayer 816 above is through LCHs. The MAC sublayer 814 therefore performs multiplexing and demultiplexing between LCHs and transport channels: the MAC sublayer 814 in the transmitting side constructs MAC PDUs (also known as transport blocks (TBs)) from MAC service data units (SDUs) received through LCHs, and the MAC sublayer 814 in the receiving side recovers MAC SDUs from MAC PDUs received through transport channels.

The MAC sublayer 814 provides a data transfer service for the RLC sublayer 816 through LCHs, which are either control LCHs which carry control data (e.g., RRC signaling) or traffic LCHs which carry user plane data. On the other hand, the data from the MAC sublayer 814 is exchanged with the PHY layer 812 through transport channels, which are classified as UL or DL. Data is multiplexed into transport channels depending on how it is transmitted over the air.

The PHY layer 812 is responsible for the actual transmission of data and control information via the air interface, i.e., the PHY layer 812 carries all information from the MAC transport channels over the air interface on the transmission side. Some of the important functions performed by the PHY layer 812 include coding and modulation, link adaptation (e.g., adaptive modulation and coding (AMC)), power control, cell search and random access (for initial synchronization and handover purposes) and other measurements (inside the Third Generation Partnership Project (3GPP) system (i.e., NR and/or LTE system) and between systems) for the RRC layer 822. The PHY layer 812 performs transmissions based on transmission parameters, such as the modulation scheme, the coding rate (i.e., the modulation and coding scheme (MCS) which indicates both the modulation order and coding rate), the number of physical resource blocks (PRBs), etc.

In 5G NR, the resource block (RB) typically spans 12 subcarriers, and the BW of the RB depends on the SCS used in the 5G NR system. For example, for 15 kHz SCS, the BW of one RB is 180 kHz, while for 30 kHz SCS, the BW of one RB is 360 kHz. Similarly, for 80 kHz SCS, the BW of one RB is 920 kHz, while for 120 kHz SCS, the BW of one RB is 1.44 MHz.

The duration of an RB in time is one slot, which may be composed of, for example, 14 OFDM symbols in the time domain. In 5G NR, the time duration of an RB is based on the slot duration, which may vary according to the numerology and SCS used. For example, for 15 kHz SCS, the time duration of one RB (i.e., slot duration) is 1 msec, while for 30 kHz SCS, the time duration of one RB (slot duration) is 0.5 msec. Similarly, for 80 kHz SCS, the time duration of one RB (i.e., slot duration) is 0.25 msec, while for 120 kHz SCS, the time duration of one RB (slot duration) is 0.125 msec.

In some implementations, the protocol stack 800 may be an NR protocol stack used in a 5G NR system. An LTE protocol stack includes similar structure to the protocol stack 800, with the differences that the LTE protocol stack lacks the SDAP sublayer 820 in the AS layer 826, that an EPC replaces the 5GC 810, and that the NAS layer 824 is between the UE 806 and an MME in the EPC. Also, the present disclosure distinguishes between a protocol layer (such as the aforementioned PHY layer 812, MAC sublayer 814, RLC sublayer 816, PDCP sublayer 818, SDAP sublayer 820, RRC layer 822 and NAS layer 824) and a transmission layer in multiple-input multiple-output (MIMO) communication (also referred to as a “MIMO layer” or a “data stream”).

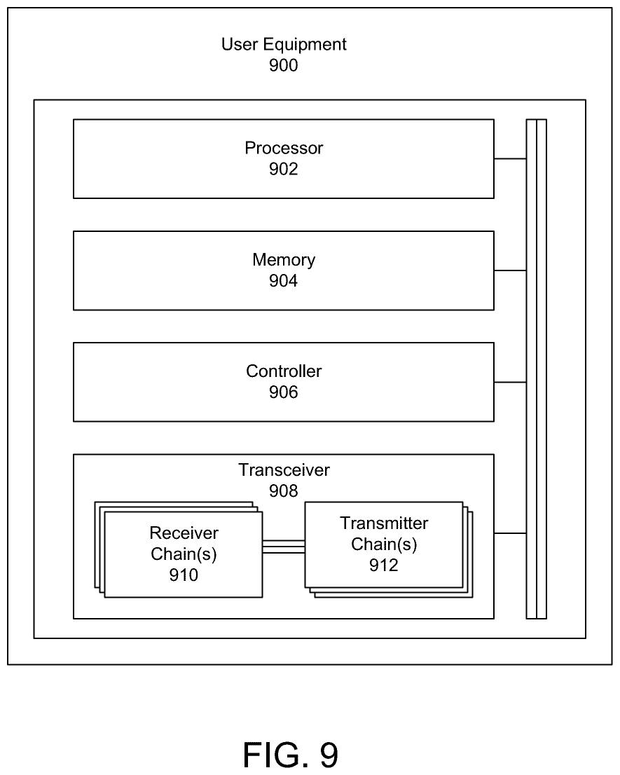

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a central processing unit (CPU), an ASIC, a field programmable gate array (FPGA), or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions that, when executed by the processor 902, cause the UE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform various functions (e.g., operations, signaling) described herein (e.g., executing, by the processor 902, instructions stored in the memory 904). In some implementations, the processor 902 may include multiple processors and the memory 904 may include multiple memories. One or more of the multiple processors may be coupled with one or more of the multiple memories, which may be individually or collectively, configured to perform various functions (e.g., operations, signaling) of the UE 900 as described herein.

The processor 902 coupled with the memory 904 may be configured to, capable of, or operable to cause the UE 900 to transmit a preamble for synchronization (e.g., SP sequence) on a resource (e.g., a PSCH resource); receive a response message (e.g., SR message) based at least in part on the transmitted preamble for synchronization, where the response message comprises at least one parameter for synchronization including one or more time and frequency correction values, where the one or more time and frequency correction values are associated with the resource, and where the response message is received on a channel dedicated for pre-synchronization; and transmitting one or more random access messages using the at least one parameter for synchronization including the one or more time and frequency correction values.

In some implementations, the processor 902 coupled with the memory 904 may be configured to, capable of, or operable to cause the UE 900 to select the resource (e.g., PSCH resource) from a pre-configured resource grid comprising periodic time-frequency resources for transmission of the preamble for synchronization (e.g., SP transmission). In certain implementations, the processor 902 coupled with the memory 904 may be configured to, capable of, or operable to cause the UE 900 to receive a configuration for the PSCH grid, where the configuration comprises a plurality of grid parameters defining the PSCH grid.

In certain implementations, prior to selecting the resource (e.g., PSCH resource), the processor 902 coupled with the memory 904 may be configured to, capable of, or operable to cause the UE 900 to receive and decode configuration parameters for the resource grid (e.g., PSCH grid) and the channel dedicated for pre-synchronization from a SIB. In certain implementations, the PSCH grid parameters include one or more of: a center frequency, a BW, a SCS value, a numerology, a frame periodicity, a repetition count, and/or a transmit power offset. Beneficially, having periodic time-frequency resources for SP transmission allows the PSCH frequency resources to be separate from other UL resources, such as the PRACH, thereby mitigating interference of the SP transmission.

In certain implementations, the processor 902 coupled with the memory 904 may be configured to, capable of, or operable to cause the UE 900 to receive a SIB defining a plurality of frequency indices and time-slot indices of the resource grid (e.g., PSCH grid), and where each periodic time-frequency resource within the resource grid is uniquely identified by an RI. Beneficially, having uniquely identified PSCH resources allows the UE 900 to receive the response message without needing to embed any UE identifier in the SP transmission.

In certain implementations, prior to selecting the resource, the processor 902 coupled with the memory 904 may be configured to, capable of, or operable to cause the UE 900 to load a pre-provisioned set of configuration parameters for the resource grid (e.g., PSCH grid) and the channel dedicated for pre-synchronization (e.g., PSRCH) or embedded in a firmware from a SIM or embedded in a firmware of the UE. Beneficially, having periodic time-frequency resources for SR reception allows the PSRCH frequency resources to be separate from other DL resources, thereby mitigating interference of the SR reception.

In some implementations, the preamble for synchronization comprises a sequence modulated by a linear frequency-modulated chirp waveform, and where the sequence comprises a CAZAC sequence or ZC sequence. Beneficially, the modulated sequence increases robustness against Doppler and timing uncertainties, as CAZAC sequences and ZC sequences are optimized for detection in very noisy conditions over a wide range of timing offsets.

In some implementations, the resource (e.g., PSCH resource) comprises a set of consecutive OFDM symbols, where the processor 902 coupled with the memory 904 may be configured to, capable of, or operable to cause the UE 900 to transmit the preamble for synchronization over a plurality of contiguous PRBs and a subset of the consecutive OFDM symbols, and where a remainder of the set of consecutive OFDM symbols forms a guard interval. Beneficially, the guard interval(s) mitigate inter-symbol interference. Additionally, in certain implementations, the resource may include one or more guard subcarriers to mitigate inter-carrier interference.

In some implementations, the processor 902 coupled with the memory 904 may be configured to, capable of, or operable to cause the UE 900 to: A) receive a repetition count, R, from a base station; and B) consecutively transmit the preamble for synchronization R times. Beneficially, transmitting multiple repetitions of the SP improves the likelihood of SP detection.

In some implementations, the response message (e.g., SR message) comprises one or more of: an RI associated with one or more detected preambles for synchronization, a quantized TA value, a quantized Doppler correction, or a CRC. In certain implementations, the response message may also include a confidence metric or a received power level associated with the detected preamble for synchronization. Beneficially, the SR contents allow the UE 900 to achieve coarse synchronization and improve the likelihood of successful detection of the random access messages.

In some implementations, the processor 902 coupled with the memory 904 may be configured to, capable of, or operable to cause the UE 900 to: A) transmit the preamble for synchronization in a frame (e.g., PSCH frame), and B) receive the response message (e.g., SR message) within a response window (e.g., PSRCH window) corresponding to the frame. In certain implementations, the response message may include a SR preamble and a SR payload. Beneficially, the inclusion of both SR preamble and SR payload may enable the UE 900 without synchronization to detect the SR message response message (e.g., SR message) under large Doppler uncertainty.

In some implementations, the processor 902 coupled with the memory 904 may be configured to, capable of, or operable to cause the UE 900 to receive the response message within a message burst (e.g., SR message burst) comprising a plurality of response messages (e.g., SRs) multiplexed within a frame of the channel dedicated for pre-synchronization (e.g., PSRCH frame), for example, using TDM or FDM, each of the plurality of response messages having an associated RI value (e.g., corresponding to a detected SP transmission). Beneficially, the multiplexing of SR messages improves spectral efficiency and reduces SR overhead.

In some implementations, the processor 902 coupled with the memory 904 may be configured to, capable of, or operable to cause the UE 900 to: A) determine a collision event based on an absence of the response message (e.g., SR message) within a monitoring window (e.g., a configured SR monitoring window); B) wait for a random backoff duration; C) re-select a new resource (e.g., new PSCH resource) for retransmission of the preamble for synchronization; and D) receive the response message in response to the retransmission of the preamble for synchronization. Beneficially, this random backoff and re-selection significantly reduces the likelihood of persistent collisions in subsequent attempts.

The controller 906 may manage input and output signals for the UE 900. The controller 906 may also manage peripherals not integrated into the UE 900. In some implementations, the controller 906 may utilize an operating system (OS) such as iOS®, ANDROID®, WINDOWS®, or other OSs. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

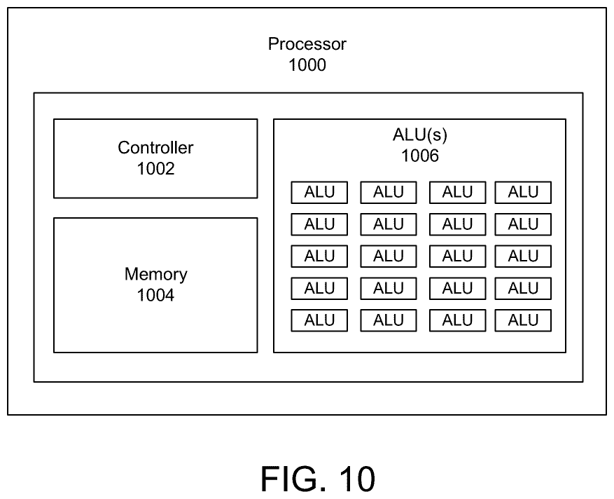

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1, or L2, or L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

In some implementations, the processor 1000 may support various functions (e.g., operations, signaling) of a UE, in accordance with examples as disclosed herein. For example, the controller 1002 coupled with the memory 1004 may be configured to, capable of, or operable to cause the processor 1000 to transmit a preamble for synchronization on a resource; receive a response message based at least in part on the transmitted preamble for synchronization, wherein the response message comprises at least one parameter for synchronization including one or more time and frequency correction values, wherein the one or more time and frequency correction values are associated with the resource, and wherein the response message is received on a channel dedicated for pre-synchronization; and transmit one or more random access messages using the at least one parameter for synchronization including the one or more time and frequency correction values. Moreover, the controller 1002 coupled with the memory 1004 may be configured to, capable of, or operable to cause the processor 1000 to perform one or more functions (e.g., operations, signaling) of the UE as described herein.

In certain implementations, the processor 1000 may support various functions (e.g., operations, signaling) of a RAN node (e.g., base station or gNB), in accordance with examples as disclosed herein. For example, the controller 1002 coupled with the memory 1004 may be configured to, capable of, or operable to cause the processor 1000 to configure a resource grid comprising periodic time-frequency resources for transmission of a preamble for synchronization; receive the preamble for synchronization on a resource of the resource grid; transmit a response message based at least in part on the transmitted preamble for synchronization, wherein the response message comprises at least one parameter for synchronization including one or more time and frequency correction values, wherein the one or more time and frequency correction values are associated with the resource, and wherein the response message is transmitted on a channel dedicated for pre-synchronization; and receive one or more random access messages using the at least one parameter for synchronization including the one or more time and frequency correction values. Moreover, the controller 1002 coupled with the memory 1004 may be configured to, capable of, or operable to cause the processor 1000 to perform one or more functions (e.g., operations, signaling) of the RAN node as described herein.

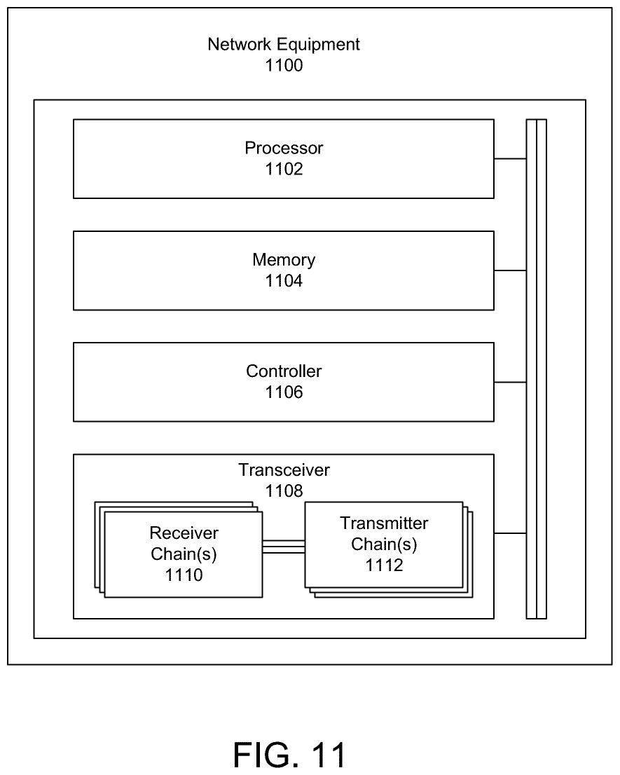

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform various functions (e.g., operations, signaling) described herein (e.g., executing, by the processor 1102, instructions stored in the memory 1104). In some implementations, the processor 1102 may include multiple processors and the memory 1104 may include multiple memories. One or more of the multiple processors may be coupled with one or more of the multiple memories, which may be individually or collectively, configured to perform various functions (e.g., operations, signaling) of the NE 1100 as described herein.

The processor 1102 coupled with the memory 1104 may be configured to, capable of, or operable to cause the NE 1100 to configure a resource grid (e.g., a PSCH grid) comprising periodic time-frequency resources for transmission of a preamble for synchronization; receive (e.g., from a UE) the preamble for synchronization on a resource of the resource grid; transmit (e.g., to the UE) a response message based at least in part on the transmitted preamble for synchronization, wherein the response message comprises at least one parameter for synchronization including one or more time and frequency correction values, wherein the one or more time and frequency correction values are associated with the resource, and wherein the response message is transmitted on a channel dedicated for pre-synchronization; and receive one or more random access messages using the at least one parameter for synchronization including the one or more time and frequency correction values.

In some implementations, the processor 1102 coupled with the memory 1104 may be configured to, capable of, or operable to cause the NE 1100 to transmit a SIB defining a plurality of frequency indices and time-slot indices of the resource grid (e.g., PSCH grid), and wherein each periodic time-frequency resource within the resource grid is uniquely identified by an RI. In certain implementations, to configure the resource grid, the processor 1102 coupled with the memory 1104 may be configured to, capable of, or operable to cause the NE 1100 to transmit a SIB defining configuration parameters for the resource grid (e.g., PSCH grid) and the channel dedicated for pre-synchronization (e.g., PSRCH). In certain implementations, the PSCH grid parameters include one or more of: a center frequency, a BW, a SCS value, a numerology, a frame periodicity, a repetition count, and/or a transmit power offset. Beneficially, having periodic time-frequency resources for SP reception allows the PSCH frequency resources to be separate from other UL resources, such as the PRACH, thereby mitigating interference of the SP reception.

In some implementations, the preamble for synchronization comprises a sequence modulated by a linear frequency-modulated chirp waveform, and wherein the sequence comprises a CAZAC sequence or ZC sequence. Beneficially, the modulated sequence increases robustness against Doppler and timing uncertainties.

In some implementations, the resource (e.g., PSCH resource) comprises a set of consecutive OFDM symbols, where the processor 1102 coupled with the memory 1104 may be configured to, capable of, or operable to cause the NE 1100 to receive the preamble for synchronization over a plurality of contiguous PRBs and a subset of the consecutive OFDM symbols, and where a remainder of the set of consecutive OFDM symbols forms a guard interval. Beneficially, the guard interval(s) mitigate inter-symbol interference. Additionally, in certain implementations, the resource may include one or more guard subcarriers.

In some implementations, the processor 1102 coupled with the memory 1104 may be configured to, capable of, or operable to cause the NE 1100 to: A) transmit a repetition count, R, to the UE; and B) consecutively receive the preamble for synchronization R times. Beneficially, transmitting multiple repetitions of the SP improves the likelihood of SP detection.

In some implementations, the response message (e.g., SR message) comprises one or more of: an RI associated with one or more detected preambles for synchronization, a quantized TA value, a quantized Doppler correction, or a CRC. In certain implementations, the response message may also include a confidence metric or a received power level associated with the detected preamble for synchronization. Beneficially, the SR contents allow the UE to achieve coarse synchronization and improves the likelihood of successful detection of the random access messages.

In some implementations, the processor 1102 coupled with the memory 1104 may be configured to, capable of, or operable to cause the NE 1100 to: A) receive the preamble for synchronization in a frame (e.g., PSCH frame); and B) transmit the response message within a response window corresponding to the frame. In certain implementations, the response message may include a SR preamble and a SR payload. Beneficially, the inclusion of both SR preamble and SR payload may enable the UE without synchronization to detect the SR message response message (e.g., SR message) under large Doppler uncertainty.

In some implementations, the processor 1102 coupled with the memory 1104 may be configured to, capable of, or operable to cause the NE 1100 to transmit the response message within a message burst (e.g., SR message burst) comprising a plurality of response messages (e.g., SRs) multiplexed within a frame of the channel dedicated for pre-synchronization (e.g., a PSRCH frame), for example, using TDM or FDM, each of the plurality of response messages having an associated RI value (e.g., corresponding to a detected SP transmission). Beneficially, the multiplexing of SR messages improves spectral efficiency and reduces SR overhead.

The controller 1106 may manage input and output signals for the NE 1100. The controller 1106 may also manage peripherals not integrated into the NE 1100. In some implementations, the controller 1106 may utilize an OS such as iOS®, ANDROID®, WINDOWS®, or other OSs. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receiving the signal over the air or wireless medium. The receiver chain 1110 may include at least one amplifier (e.g., an LNA) configured to amplify the received signal. The receiver chain 1110 may include at least one demodulator configured to demodulate the received signal and obtain the transmitted data by reversing the modulation technique applied during transmission of the signal. The receiver chain 1110 may include at least one decoder for decoding/processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

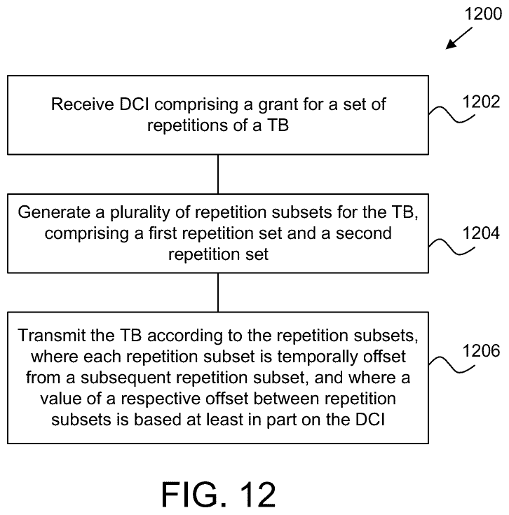

FIG. 12 illustrates a flowchart of a method 1200 in accordance with aspects of the present disclosure. The operations of the method 1200 may be implemented by a UE as described herein. In some implementations, the UE may execute a set of instructions to control the function elements of the UE to perform the described functions.

At step 1202, the method 1200 may include transmitting a preamble for synchronization on a resource. The operations of step 1202 may be performed in accordance with examples as described herein. In some implementations, aspects of the operations of step 1202 may be performed by a UE, as described with reference to FIG. 9.

At step 1204, the method 1200 may include receiving a response message based at least in part on the transmitted preamble for synchronization, wherein the response message comprises at least one parameter for synchronization including one or more time and frequency correction values, wherein the one or more time and frequency correction values are associated with the resource, and wherein the response message is received on a channel dedicated for pre-synchronization. The operations of step 1204 may be performed in accordance with examples as described herein. In some implementations, aspects of the operations of step 1204 may be performed by a UE, as described with reference to FIG. 9.

At step 1206, the method 1200 may include transmitting one or more random access messages using the at least one parameter for synchronization including the one or more time and frequency correction values. The operations of step 1206 may be performed in accordance with examples as described herein. In some implementations, aspects of the operations of step 1206 may be performed by a UE, as described with reference to FIG. 9.

It should be noted that the method 1200 described herein describes one possible implementation, and that the operations and the steps may be rearranged or otherwise modified and that other implementations are possible.

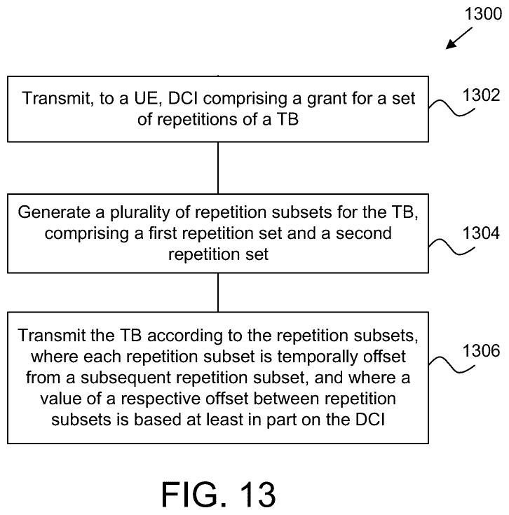

FIG. 13 illustrates a flowchart of a method 1300 in accordance with aspects of the present disclosure. The operations of the method 1300 may be implemented by a base station, such as an NE as described herein. In some implementations, the base station may execute a set of instructions to control the function elements of the base station to perform the described functions.

At step 1302, the method 1300 may include configuring a resource grid comprising periodic time-frequency resources for transmission of a preamble for synchronization. The operations of step 1302 may be performed in accordance with examples as described herein. In some implementations, aspects of the operations of step 1302 may be performed by a NE, as described with reference to FIG. 11.

At step 1304, the method 1300 may include receiving the preamble for synchronization on a resource of the resource grid. The operations of step 1304 may be performed in accordance with examples as described herein. In some implementations, aspects of the operations of step 1304 may be performed by a NE, as described with reference to FIG. 11.

At step 1306, the method 1300 may include transmitting a response message based at least in part on the transmitted preamble for synchronization, wherein the response message comprises at least one parameter for synchronization including one or more time and frequency correction values, wherein the one or more time and frequency correction values are associated with the resource, and wherein the response message is transmitted on a channel dedicated for pre-synchronization. The operations of step 1306 may be performed in accordance with examples as described herein. In some implementations, aspects of the operations of step 1306 may be performed by a NE, as described with reference to FIG. 11.

At step 1308, the method 1300 may include receiving one or more random access messages using the at least one parameter for synchronization including the one or more time and frequency correction values. The operations of step 1308 may be performed in accordance with examples as described herein. In some implementations, aspects of the operations of step 1308 may be performed by a NE, as described with reference to FIG. 11.

It should be noted that the method 1300 described herein describes one possible implementation, and that the operations and the steps may be rearranged or otherwise modified and that other implementations are possible.

What is claimed is:

1. A user equipment (UE) for wireless communication, comprising:
at least one memory; and
at least one processor coupled with the at least one memory and configured to cause the UE to:
transmit a preamble for synchronization on a resource;
receive a response message based at least in part on the transmitted preamble for synchronization, wherein the response message comprises at least one parameter for synchronization including one or more time and frequency correction values, wherein the one or more time and frequency correction values are associated with the resource, and wherein the response message is received on a channel dedicated for pre-synchronization; and
transmit one or more random access messages using the at least one parameter for synchronization including the one or more time and frequency correction values.

2. The UE of claim 1, wherein the at least one processor is configured to cause the UE to select the resource from a pre-configured resource grid comprising periodic time-frequency resources for transmission of the preamble for synchronization.

3. The UE of claim 2, wherein the at least one processor is configured to cause the UE to receive a system information block (SIB) defining a plurality of frequency indices and time-slot indices of the pre-configured resource grid, and wherein each periodic time-frequency resource within the pre-configured resource grid is uniquely identified by a resource identifier.

4. The UE of claim 2, wherein prior to selecting the resource, the at least one processor is configured to cause the UE to receive and decode configuration parameters for the pre-configured resource grid and the channel dedicated for pre-synchronization from a system information block (SIB).

5. The UE of claim 2, wherein prior to selecting the resource, the at least one processor is configured to cause the UE to load a pre-provisioned set of configuration parameters for the pre-configured resource grid and the channel dedicated for pre-synchronization or embedded in a firmware from a subscriber identity module (SIM) or embedded in a firmware of the UE.

6. The UE of claim 1, wherein the preamble for synchronization comprises a sequence modulated by a linear frequency-modulated chirp waveform, and wherein the sequence comprises a constant-amplitude zero auto-correlation (CAZAC) sequence or Zadoff-Chu (ZC) sequence.

7. The UE of claim 1, wherein the resource comprises a set of consecutive orthogonal frequency-division multiplexing (OFDM) symbols, wherein the at least one processor is configured to cause the UE to transmit the preamble for synchronization over a plurality of contiguous physical resource blocks (PRBs) and a subset of the consecutive OFDM symbols, and wherein a remainder of the set of consecutive OFDM symbols forms a guard interval.

8. The UE of claim 1, wherein the at least one processor is configured to cause the UE to:
receive a repetition count, R, from a base station; and
consecutively transmit the preamble for synchronization R times.

9. The UE of claim 1, wherein the response message comprises one or more of: a resource identifier associated with one or more detected preambles for synchronization, a quantized timing advance (TA) value, a quantized Doppler correction, or a cyclic redundancy check (CRC).

10. The UE of claim 1, wherein the at least one processor is configured to cause the UE to:
transmit the preamble for synchronization in a frame, and
receive the response message within a response window corresponding to the frame.

11. The UE of claim 1, wherein the at least one processor is configured to cause the UE to receive the response message within a message burst comprising a plurality of response messages multiplexed within a frame of the channel dedicated for pre-synchronization using time-division multiplexing or frequency-division multiplexing, each of the plurality of response messages having an associated resource identifier value.

12. The UE of claim 1, wherein the at least one processor is configured to cause the UE to:
determine a collision event based on an absence of the response message within a monitoring window;
wait for a random backoff duration;
re-select a new resource for retransmission of the preamble for synchronization; and
receive the response message in response to the retransmission of the preamble for synchronization.

13. A method performed by a user equipment (UE), the method comprising:
transmitting a preamble for synchronization on a resource;
receiving a response message based at least in part on the transmitted preamble for synchronization, wherein the response message comprises at least one parameter for synchronization including one or more time and frequency correction values, wherein the one or more time and frequency correction values are associated with the resource, and wherein the response message is received on a channel dedicated for pre-synchronization; and
transmitting one or more random access messages using the at least one parameter for synchronization including the one or more time and frequency correction values.

14. A base station for wireless communication, comprising:
at least one memory; and
at least one processor coupled with the at least one memory and configured to cause the base station to:
configure a resource grid comprising periodic time-frequency resources for transmission of a preamble for synchronization;
receive the preamble for synchronization on a resource of the resource grid;
transmit a response message based at least in part on the transmitted preamble for synchronization, wherein the response message comprises at least one parameter for synchronization including one or more time and frequency correction values, wherein the one or more time and frequency correction values are associated with the resource, and wherein the response message is transmitted on a channel dedicated for pre-synchronization; and
receive one or more random access messages using the at least one parameter for synchronization including the one or more time and frequency correction values.

15. The base station of claim 14, wherein the at least one processor is configured to cause the base station to transmit a system information block (SIB) defining a plurality of frequency indices and time-slot indices of the resource grid, and wherein each periodic time-frequency resource within the resource grid is uniquely identified by a resource identifier.

16. The base station of claim 14, wherein the preamble for synchronization comprises a sequence modulated by a linear frequency-modulated chirp waveform, and wherein the sequence comprises a constant-amplitude zero auto-correlation (CAZAC) sequence or Zadoff-Chu (ZC) sequence.

17. The base station of claim 14, wherein the response message comprises one or more of: a resource identifier associated with one or more detected preambles for synchronization, a quantized timing advance (TA) value, a quantized Doppler correction, or a cyclic redundancy check (CRC).

18. The base station of claim 14, wherein the at least one processor is configured to cause the base station to:
receive the preamble for synchronization in a frame; and
transmit the response message within a response window corresponding to the frame.

19. The base station of claim 14, wherein the at least one processor is configured to cause the base station to transmit the response message within a message burst comprising a plurality of response messages multiplexed within a frame of the channel dedicated for pre-synchronization using time-division multiplexing or frequency-division multiplexing, each of the plurality of response messages having an associated resource identifier value.

20. A method performed by a base station, the method comprising:
configuring a resource grid comprising periodic time-frequency resources for (SP) transmission of a preamble for synchronization;
receiving the preamble for synchronization on a resource of the resource grid;
transmitting a response message based at least in part on the transmitted preamble for synchronization, wherein the response message comprises at least one parameter for synchronization including one or more time and frequency correction values, wherein the one or more time and frequency correction values are associated with the resource, and wherein the response message is transmitted on a channel dedicated for pre-synchronization; and
receiving one or more random access messages using the at least one parameter for synchronization including the one or more time and frequency correction values.
